(19) United States
(12) Patent Application Publication
(10) Pub. No.: US 2018/0344434 A1
(43) Pub. Date: Dec. 6, 2018

(54) MULTI-COMPONENT DENTAL IMPLANT SYSTEM

(71) Applicant: John P. POOVEY, Grand Junction, CO (US)

(72) Inventor: John P. POOVEY, Grand Junction, CO (US)

(21) Appl. No.: 16/100,665

(22) Filed: Aug. 10, 2018

Related U.S. Application Data
(63) Continuation-in-part of application No. 14/778,930, filed on Sep. 21, 2015.
(60) Provisional application No. 61/804,159, filed on Mar. 21, 2013.

(51) Int. Cl. A61C 8/00

(52) U.S. Cl. CPC A61C 8/0069; A61C 8/0054; A61C 8/0037

(57) ABSTRACT

Dental implants for fixed and removable prosthetic devices, having application to single tooth replacement, e.g., caps and crowns, and multiple tooth replacement using one or more implants, e.g., bridges, and multiple implants for full and partial prosthetic devices. Dental implants include an implant and an abutment configured to mate with the implant in a non-rotatable fashion. The implant may have a cylindrical or a non-cylindrical shape. In one embodiment, the dental implant includes a first stage implant and a second stage implant. The second stage implant is interconnectable to the first stage implant and includes an abutment with an anatomical emergence profile. Further, dental reconstruction and abutment installation methods utilizing the dental implant systems and instruments are disclosed. Also provided are impression taking procedures, and impression copings that produce an accurate fit between the dental prosthesis and the dental implant.

### CROSS REFERENCE TO RELATED APPLICATION

This application is a continuation-in-part of U.S. patent application Ser. No. 14/778,930 having a filing date of Sep. 21, 2015 which is a national stage application under 35 U.S.C. 371 of PCT Application No. PCT/US2014/031390 having an international filing date of Mar. 21, 2014, which designated the United States, which PCT application claimed the benefit of U.S. application Ser. No. 61/804,159, filed Mar. 21, 2013, which are each incorporated by reference in their entirety.

### TECHNICAL FIELD

This disclosure describes a dental implant system having improved structural features for ensuring proper alignment and orientation with improved implant stability and fixation and which prevents the rotation of the superstructures, such as a post or abutment, on the implant body of an abutment assembled on an implant. This disclosure also provides methods and materials for preparing an accurate dental impression and mold representing the implantation site and its relationship to adjacent teeth structure. The disclosure further describes a multi-component kit containing the dental implant system components and related devices and instructions for proper use and implantation.

### BACKGROUND

Natural teeth in the human mouth are supported in bone by periodontal fibers that function as shock absorbers when a compressive force is applied, such as during chewing. Through disease, accidental injury, anatomical abnormalities, age, and the like, a natural tooth may be removed or missing, such that a dental appliance or prosthetic device (e.g. a crown) is implanted in the patient's bone structure to improve the patient's physical appearance and/or quality of mastication. However, conventional implants are often too rigid to function like natural teeth. Problems such as crown breakage, crown rotation, screw loosening and screw breakage are inherent problems with a rigid crown implant. Failure is also known to occur when an implant is used in a bridge abutment with a natural tooth or when improper occlusion is created by the implant crown.

As shown in FIG. 1, most conventional dental implants include an implant 1 having a screw part, and an abutment 3 integrally formed with the upper end of the implant, such that the implant and the abutment 3 are fixedly secured to each other by means of a screw 4. The abutment is secured to a dental prosthesis (such as a crown) 2 whereby combined 5, the dental prosthesis 2 covers the abutment 3, leaving the implant imbedded in the patient's jawbone.

FIG. 2 shows such conventional dental implant 1 supporting a crown 2 between adjacent teeth 6. Embrasures, or periodontal gaps 12 between the bottom portion of the crown 2 and adjacent teeth 6 may become irritated or infected following food impaction and collection.

Screws associated with conventional crowns sometimes break because of over tightening and due to tension and lateral stress to which the crown is subjected during use. Besides the time and inconvenience associated with conventional procedures for implanting, it is also difficult in some cases to properly orient the implant and maintain it in a stable orientation after the prosthesis has been fitted. This can contribute to longer healing periods before the implant and the bony tissue integrate because of the lack of substantial close bone contact. Screw-type implants also are difficult to orient and stabilize. Typically, the thread pattern of screw-type implants requires multiple turns to set the implant. The hardness of the bony tissue in and around the implant cavity varies. With a multiple-turn implant, the threads tend to draw the implant towards and through softer bony tissue. This can result in the entire implant misaligning within the alveolar bone structure of the patient. Such implants are typically designed such that they conform to a generally cylindrical configuration. In addition, typical implants are of a single piece construction and do not include additional or auxiliary means for interlocking the implant to the alveolar bone structure.

Once the prosthesis has been attached to the top portion of the implant and the patient starts to use the implant to chew food, the stress, vertical and lateral forces, as well as frequent temperature changes of over 100° F. from hot versus cold foods and liquids, and rotational torques placed on the prosthesis, are transferred downwardly to the implant. In cases where the implant is not stable and tightly secured within the implant cavity, the implant tends to rotate and turn under these stresses and torque. This results in the implant becoming loose within the implant cavity and that often results in the implant becoming dislodged from the cavity or being so loose and unstable within the cavity that the implant must be removed from the patient's alveolar bone. Imperfections in the manufacture of dental implant systems also contribute to screw loosening.

It is expensive and time consuming to retrieve and/or repair such loose or broken screws. In addition, special purpose torque drivers are required to install the screws. Once the crown is implanted, it may take several months to achieve suitable bone integration of the root portion with the surrounding bone structure thereby resulting in increased loading time before the root portion can be reliably anchored. Improperly anchored implants or crowns loosened by rotation may be susceptible to damage or reduced life and may be unable to provide the function of a natural tooth, including the quality of mastication.

Accordingly, it is desirable to overcome the problems associated with conventional crowns by avoiding dental implant system screws which can break or loosen due to rotation of the crown. It would also be desirable to decrease integration time by increasing stabilization between the root portion of the implant and the bone structure of the patient. With such system, patient comfort will be enhanced, the life of the crown will be increased, and the need to make repairs, and corresponding costs, can be reduced.

Each of the foregoing disadvantages are overcome by the implant system and methods provided in this disclosure. Additionally, the implant system and methods provided in this disclosure achieve other advantages described more fully below.

### SUMMARY

In one aspect, this disclosure provides a dental implant adapted to be embedded within a patient's jawbone comprising a non-cylindrical apical end adapted to engage the jaw bone, and a top end, opposite the apical end, the top end having an abutment or prosthesis receiving portion. In some embodiments, the apical end of the dental implant has a shape substantially consistent with a square, an oval, a rectangle, a pentagon, or a hexagon. In one embodiment, the dental implant has an apical end shaped substantially consistent with a rectangle. In another embodiment, the dental implant has an apical end shaped substantially consistent with an hourglass in the mesial-distal plane, having two wider lobes, and a narrower center portion between the two lobes.

The dental implants of this disclosure may be made of at least one material selected from titanium or titanium alloys, gold alloys, zirconium, and a ceramic.

The dental implants of this disclosure may have a smooth surface texture or a rough surface texture. Additionally, these dental implants may have one surface portion with a rough surface texture, and one surface portion with a smooth surface texture.

Dental implants of this disclosure may have a surface coating with materials selected from an artificial hydroxyapatite, a bisphosphonate, a platelet-rich plasma (PRP), a PRP-bone matrix mix, and combinations thereof. Such surface coatings may be uniformly applied over the external surface of the implant, or the surface coating may be applied to only a portion of an external surface of the implant. For example, such surface coatings may be applied to a portion of an external surface of the implant that resides below the gum line in the surrounding tissues within the patient's mouth following implantation of the implant. Alternatively, such coating may be absent in a portion of the external surface of the implant that will reside above the gum line in the surrounding tissues within the patient's mouth following implantation of the implant. In certain embodiments, the external surface of the implant that will reside above the gum line in the surrounding tissues within the patient's mouth is smooth and free of surface coatings.

In certain embodiments, the dental implant of this disclosure may include a top end that is adapted to receive a prosthesis without the use of an abutment. In some embodiments, the dental implants of this disclosure may be formed such that the top end comprises a dental fixture integrally formed with the implant. In other embodiments, the dental implant has a top end adapted to receive an abutment. Such abutment-receiving portion of the implant may be a cavity formed within the top end of the implant to receive an abutment, or other dental prosthetic structure. The abutment-receiving portion of the implant may include a plurality of projections formed on an interior wall of the cavity comprising the abutment-receiving portion of the implant. Such projections may extend from the interior wall into the cavity comprising the abutment-receiving portion of the implant. Such projections are of a size and/or shape to engage with an abutment in a manner that will prevent rotation of an abutment disposed in the abutment-receiving portion of the implant. Such projections may be located in the cavity comprising the abutment receiving portion of the implant in a non-symmetrical pattern that will prevent rotation of an abutment disposed in the abutment-receiving portion of the implant. The projections may have a shape that prevents the rotation of an abutment disposed in the abutment-receiving portion of the implant. In a specific embodiment, the dental implant has an abutment-receiving portion that has a substantially pentagonal shape. In other embodiments, the dental implant may have an abutment receiving portion which has a substantially non-cylindrical shape selected from a square, an oval, a rectangle, a hexagon, and an hourglass shape.

In one embodiment, the dental implant has an abutment-receiving portion which comprises a cavity formed within the implant to receive an abutment, or other dental prosthetic structure, and the cavity further comprises a hole configured for receiving a fixation implant screw that will secure the implant into a jawbone. Such hole may comprise a circular opening in the apical end adapted for receiving a fixation screw that will pass through the circular opening in the abutment-receiving portion and extend below the apical end of the implant, and into a jawbone. Such hole in the apical end of the implant may have a countersunk central opening adapted to fit a countersink head on the fixation screw.

Another aspect provided by this disclosure is a dental implant abutment adapted to receive a dental prosthesis surmounted with a crown, or other dental fixture. The abutment comprises an implant insertion portion and prosthesis receiving portion opposite the implant insertion portion.

Such abutment may comprise a material including titanium, zirconium, or a combination thereof. In one embodiment, the abutment has an implant insertion portion that has a substantially pentagonal shape. In other embodiments, the abutment has an implant insertion portion that has a shape substantially consistent with a square, an oval, a rectangle, a pentagon, a hexagon, or an hourglass shape. In specific embodiments, the dental implant abutment has an implant insertion portion having a substantially cylindrical shape comprising a plurality of indentations configured to mate with projections on an abutment-receiving portion of a dental implant.

Another aspect provided by the present disclosure is a surgical drill guide adapted to guide the formation of drill holes in a jawbone comprising a guide comprising a plurality of holes of varying sizes and spatial arrangements that will guide a dental drill into the jawbone to form patterns of drill holes.

Another aspect provided by the present disclosure is a method for securing a dental prosthesis to a patient's jawbone, including drilling at least one pilot hole in the jawbone to form an extraction cavity, expanding the extraction cavity to accept a non-cylindrical implant, setting a non-cylindrical implant into the extraction cavity, affixing a dental prosthesis on the non-cylindrical implant. The drilling may be conducted using a surgical drill guide secured about an extraction site to guide the formation of pilot holes. The surgical drill guide may include a plurality of holes of various sizes and spatial arrangements configured to guide a dental drill into the jawbone to form patterns of drill holes. The expanding step may include using an osteotome to expand the extraction cavity to fit the chosen implant. The expanding step may also include reaming to shape and contour the extraction cavity to accept the selected implant. The affixing step may include anchoring the non-cylindrical implant to the jawbone with a fixation screw extending from an apical end of the non-cylindrical implant. The method may include closing the implant site after setting the non-cylindrical implant into the extraction cavity prior to affixing a dental prosthesis on the non-cylindrical implant. The method may include attaching a temporary cap to the non-cylindrical implant after setting the non-cylindrical implant into the extraction site. The method may include closing the implant site by placing a gingival flap across the non-cylindrical implant. The affixing step may be conducted about 3 months to about 12 months after setting a non-cylindrical implant into the extraction cavity. The affixing step may include securing a false tooth to the implant. The affixing step may include securing an abutment to the implant. The method may include forming an impression of the non-cylindrical implant in the extraction cavity including surrounding dentitia.

Another aspect of the present disclosure provides an impression coping comprising an implant mating portion and an impression material contact portion, and a top. The impression coping may include an impression material contact portion that is substantially cylindrical. The impression material contact portion may include at least one of surface projections, surface texturing, roughening, and other surface features, to enhance contact and retention in an impression material. The implant mating portion may be configured to be received by and mate with an interior portion of a dental implant with an indented feature configured to permit a mating fit with a cooperating protrusion. The implant mating portion may include a plurality of flanges situated around the impression material contact portion, opposite the top of the impression coping. The flanges may be spaced regularly around the generally cylindrical impression material contact portion.

Another aspect of the present disclosure provides an impression coping securing screw for securing an impression coping to an implant comprising at least one material selected from a heat labile plastic and silicone. In certain embodiments, the impression coping securing screw comprises threads made of metal or plastic and coated with a heat labile plastic or silicone. In use, the impression coping securing screw is threaded into the internal threading in a dental implant by exerting a rotational force on the impression coping securing screw. At the time of removal, the heat labile plastic, or silicone threads (or heat labile plastic, or silicone-coated threads) are activated to allow the impression coping, secured by the impression coping securing screw, to be disengaged from the implant and removed with the impression of the patient's dentitia.

Another aspect of the present disclosure provides a dental implant system comprising a dental implant and an impression coping member and an impression coping securing screw comprising a heat-labile plastic or silicone material configured to cooperatively engage the dental implant and the impression coping member, thereby ensuring proper alignment and orientation of a dental prosthesis assembled on the implant.

Another aspect of the present disclosure provides a method of making an impression and dental reconstruction, which method includes providing an impression coping including a screw access channel in the impression coping configured to receive an impression coping securing screw, securing the impression coping on a dental implant set in a jawbone by passing an impression coping securing screw through the screw access channel and mating an end of the impression coping securing screw with the dental implant, activating a heat liable plastic or silicone on the impression coping securing screw to dissolve or soften the plastic or silicone sufficiently to allow removal of the impression coping securing screw from the implant without unscrewing the impression coping securing screw, and removing the impression coping securing screw from the implant. In this method, an impression material may be used to form an impression of the implant and surrounding dentitia before the step of removing the impression coping securing screw from the implant.

Another aspect of the present disclosure provides a method for obtaining an accurate translation of an orientation and position of an implant, including securing a dental implant in a jawbone, wherein the dental implant has a plurality of protrusions internal to an interior cavity of the implant, which protrusions are configured to matingly-engage flanges on an impression coping in a snap-fit engagement when the flanges extend beneath the protrusions, and seating an impression coping comprising flanges that engage two or more of the protrusions internal to the interior cavity of the implant by deflecting and springing back to an un-deflected state upon seating of the impression coping in the implant, and applying a dental impression material to at least an area adjacent the impression coping seated in the implant to cover the impression coping to obtain a negative impression of the area, and releasing the impression coping from the implant, and removing the impression material from the area adjacent the impression coping with the impression coping embedded in the impression material. In this method, engaging flanges of the impression coping with the protrusions on the implant may produce an audible sound, indicating that the impression coping has been properly seated in the implant. In a specific embodiment, a bore extends through the impression coping, the bore configured to allow the passage of an impression coping securing screw through the impression coping. In an embodiment, seating the impression coping in the implant may include passing an impression coping securing screw through the bore in the impression coping and engaging the screw in an internal cavity of the implant in a closely fitted engagement. In an embodiment, the impression coping securing screw may be a heat labile plastic, or silicone configured to cooperatively engage the implant. In an embodiment, releasing the impression coping from the implant may include activating the heat labile plastic or silicone portion of the impression coping securing screw to dissolve or soften sufficiently the plastic or silicone material to allow removal of the impression coping securing screw from the implant without unscrewing the impression coping securing screw. These methods may also include sending the impression material and impression coping to a dental lab to form a dental cast model.

Another aspect of the present disclosure provides a multi-component dental implant system including at least one non-cylindrical dental implant, at least one implant abutment configured to detachably join at least one non-cylindrical dental implant. The multi-component dental implant system may also include a set of standard surgical tools prepared for the dental professional to choose from. The at least one non-cylindrical dental implant may include a set of standard shaped implants of varying size. The at least one implant abutment may include a set of standard shaped abutments of varying size. The non-cylindrical implant may be configured to replace a tooth selected from a bicuspid, a molar, a canine, and an incisor. The multi-component dental implant system may also include at least one dental surgical instrument selected from a drill guide, a reamer, a drill bit, a surgical fixation screw, and a bone screw insertion tool. The multi-component dental implant system may also include a healing abutment. Such healing abutment need not be removed during an impression taking procedure. The multi-component dental implant system may also include an implant coding system that facilitates selection or identification of a non-cylindrical dental implant by the dental professional.

The present disclosure provides a dental implant adapted to be embedded within a patient's jawbone, wherein the dental implant has an apical end adapted to engage the jaw bone, and a top end, opposite the apical end. The top end has an abutment or prosthesis receiving portion comprising a cavity formed within the implant to receive an abutment, or other dental prosthetic structure. The abutment or prosthesis receiving portion has a substantially pentagonal shape, and at least the apical end of the dental implant has a non-cylindrical shape. In one embodiment, the abutment-receiving portion of the dental implant further comprises a circular opening in the apical end adapted for receiving a fixation screw that will pass through the circular opening in the abutment-receiving portion and extend below the apical end of the implant, and into a jawbone.

Another aspect of the present disclosure is a dental implant system adapted to be embedded within a patient's jawbone, comprising: (1) a first stage implant to engage the jawbone; and (2) a second stage implant interconnectable to the first stage implant, the second stage implant having an abutment with a recess configured to receive a crown. In one embodiment, the abutment has a non-cylindrical shape. Optionally, the recess of the abutment has a generally pentagonal or hexagonal shape.

Optionally, the first stage implant may further comprise external threads. The first stage implant may further comprise a chamber. The chamber has a geometry configured to receive an extension of the second stage implant.

In one embodiment, the chamber is configured to prevent rotation of the extension relative to the first stage implant. In another embodiment, the chamber has six interior walls arranged in a shape that is approximately hexagonal.

Optionally, an exterior surface of one or more of the first stage implant and the abutment of the second stage implant can be configured to promote osseointegration. Accordingly, in one embodiment, at least a portion of the second stage implant includes threads having a geometry selected to promote osseointegration. Additionally, or alternatively, one or more surface of the first and second stage implants may include a coating or layer configured to promote osseointegration.

In one embodiment, the abutment of the second stage implant further comprises a bone engagement portion, a gum contact portion, and a collar. The bone engagement portion can be configured to promote osseointegration. In one embodiment, the gum contact portion is configured to promote attachment of the patient's gum tissue to the abutment. In another embodiment, the bone engagement portion has a rough surface texture and the gum contact portion has a smooth or polished surface texture. In still another embodiment, the collar is configured to extend above the patient's gum tissue.

Additionally, or alternatively, the second stage implant further comprises a groove extending around a circumference of the abutment. The groove may be associated with one or more of the gum contact portion and the bone engagement portion. In one embodiment, the groove has a depth that is substantially uniform. Alternatively, the depth of the groove may vary.

In another embodiment, the abutment of the second stage implant has an anatomical emergence profile selected to substantially match an emergence profile of a tooth to be replaced by the dental implant system.

In one embodiment, the first stage implant further comprises a cylindrical bore configured to receive a threaded fastener. In this manner, the threaded fastener can secure the second stage implant to the first stage implant. Optionally, the cylindrical bore does not extend through the first stage implant. Alternatively, the cylindrical bore extends through the first stage implant such that the threaded fastener can engage the patient's jawbone.

In one embodiment, the recess includes a projection configured to engage the crown. The projection extends inwardly from a contact surface of the recess. Optionally, the recess may include a plurality of projections. In one embodiment, the projection has a generally rectangular cross section. In another embodiment, the crown includes a groove configured to engage the projection.

It is another aspect to provide a method for securing a dental implant system to a patient's jawbone. The method includes one or more of, but is not limited to: (1) forming an implant cavity in the jawbone to receive a first stage implant; (2) expanding an upper portion of the implant cavity to accept an abutment of a second stage implant, the abutment having a non-cylindrical shape; (3) threading the first stage implant into a lower portion of the implant cavity; (4) positioning an extension of the second stage implant in a chamber of the first stage implant such that an exterior surface of the abutment contacts bone tissue in the upper portion of the implant cavity; and (5) securing a threaded fastener through the second stage implant into the first stage implant.

In one embodiment, expanding the upper portion of the implant cavity comprises removing bone tissue to shape the implant cavity to accept the abutment. Optionally, the abutment may have an anatomical emergence profile selected to substantially match an emergence profile of a tooth to be replaced by the dental implant system.

In one embodiment, the method further comprises forming threads in the lower portion of the implant cavity. The threads are configured to engage external threads of the first stage implant. Optionally, the threads may have a geometry selected based on the density of the patient's bone tissue at the implant site.

The method may optionally include affixing a crown in a recess of the second stage implant. In another embodiment, affixing the crown in the recess includes aligning a groove of the crown to engage a projection within the recess of the second stage implant.

In one embodiment, the method includes closing gum tissue around the second stage implant after securing the threaded fastener into the first stage implant. In another embodiment, the gum tissue is not cut when the crown is affixed to the second stage implant.

In one embodiment, the threaded fastener extends through the first stage implant into bone tissue.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. In addition, all ranges described herein may be reduced to any sub-range or portion of the range.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

This Summary of the Disclosure is neither intended nor should it be construed as being representative of the full extent and scope of the present disclosure. Moreover, references made herein to “the present disclosure,” or aspects thereof, should be understood to mean certain embodiments of the present disclosure and should not necessarily be construed as limiting all embodiments to a particular description. The present disclosure is set forth in various levels of detail in this Summary of the Disclosure as well as in the attached drawings and the Description of Embodiments, and no limitation as to the scope of the present disclosure is intended by either the inclusion or non-inclusion of elements, components, etc. in this Summary of the Disclosure. It is contemplated that various features and devices shown and/or described with respect to one embodiment may be combined with or substituted for features or devices of other embodiments regardless of whether or not such a combination or substitution is specifically shown or described herein. Additional aspects of the present disclosure will become more readily apparent from the Description of Embodiments, particularly when taken together with the drawings.

### BRIEF DESCRIPTION OF DRAWINGS

FIG. 1 depicts parts of a standard dental implant of the prior art, including an implant, an abutment, and a crown, both separate and assembled.

FIG. 2 depicts the assembled dental implant of FIG. 1 implanted in the jaw of a patient, between two natural teeth.

FIG. 3 is a mesial-distal view of an implant of the present disclosure.

FIG. 4 is a top view of the implant of FIG. 3.

FIG. 5 is an apical view of one implant of the present disclosure, having a substantially hourglass shape.

FIG. 6 is a top view of an implant of the present disclosure.

FIG. 7 is a mesial-distal view of an implant of the present disclosure.

FIG. 8 is a top view of the implant of FIG. 7.

FIG. 9 is a side view of an abutment of the present disclosure positioned above an implant of the present disclosure.

FIG. 10 depicts a surgical guide disposed on a patient's gum line between two natural teeth.

FIG. 11 is a side view of an impression coping according to one embodiment of the present disclosure.

FIG. 12 is a partial cross-sectional view of an impression coping engaged with an implant according to an embodiment of the present disclosure.

FIG. 13 is a side view of an impression coping securing screw, according to an embodiment of the present disclosure.

FIG. 14A is a top plan view of an implant site between two natural teeth in a patient's jaw.

FIG. 14B is a cross-sectional view of the implant site taken along line 14B-14B of FIG. 14A.

FIG. 15A is another top plan view of the implant site of FIG. 14A after an implant cavity is formed.

FIG. 15B is a cross-sectional view of the implant site and the implant cavity taken along line 15B-15B of FIG. 15A.

FIG. 16A is still another view of the implant site showing an upper portion of the implant cavity which has been formed with an anatomical emergence profile.

FIG. 16B is a cross-sectional view of the implant cavity taken along line 16B-16B of FIG. 16A.

FIG. 17A is a front elevation view of a first stage implant of an embodiment of the present disclosure.

FIG. 17B is a longitudinal cross-sectional view of the first stage implant taken along line 17B-17B of FIG. 17A.

FIG. 17C is a transverse cross-sectional view of the first stage implant taken along line 17C-17C of FIG. 17A.

FIG. 18A is a front elevation view of a second stage implant of an embodiment of the present disclosure.

FIG. 18B is a longitudinal cross-sectional view of the second stage implant taken along line 18B-18B of FIG. 18A.

FIG. 18C is a transverse cross-sectional view of the second stage implant taken along line 18C-18C of FIG. 18A.

FIG. 18D is another transverse cross-sectional view of the second stage implant taken along line 18D-18D of FIG. 18A.

FIG. 19 is an exploded view of an implant system of the present disclosure and illustrating alignment of a first stage implant, a second stage implant, a threaded fastener, and an optional healing cap.

FIG. 20 illustrates an implant system of the present disclosure positioned within a patient's jaw and a crown aligned to be received in a recess of a second stage implant.

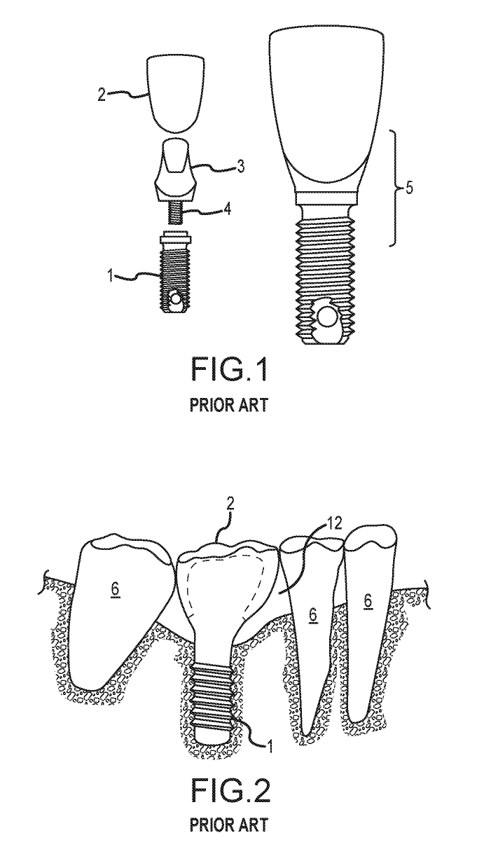

### DESCRIPTION OF ILLUSTRATIVE EMBODIMENTS

### Non-Cylindrical Dental Implant

This disclosure provides dental implants for fixed and removable prosthetic devices and certain fixed and removable prosthetic devices, including implants suitable for single tooth replacement (e.g., caps and crowns), multiple tooth replacements using one or more implants (e.g., bridges), and multiple implants for full and partial prosthetic devices. Embodiments of dental implants of the present disclosure may be installed in single or multiple root tooth locations.

Implants according to some embodiments of the present disclosure are non-cylindrical, which better facilitates the restoration by providing a more anatomically correct emergence profile, thereby improving form, function and aesthetics of the restoration. This also facilitates immediate restoration when an abutment is mated with an implant of the present disclosure, because the abutment can be tightened to the implant without any danger that the implant will rotate within the implantation site in the patient's jawbone. These non-cylindrical implants of the present disclosure will have an increased size and increased surface area compared to conventional dental implants. This increased size and surface area will improve case selection and lower the need for sinus lifts and the number of areas in which nerve proximity would be a consideration in the placement of a dental implant.

Implants according to the present disclosure can be constructed from any non-corrosive material compatible with the abutment and prosthesis and the surrounding tissues within the patient's mouth without producing immunologic reactions effecting rejection by the body. Suitable materials include titanium or titanium alloys, gold alloys, zirconium, ceramic and the like, which are machined and milled to the requisite shape. In some embodiments, one or more of an implant, an abutment, and a dental prosthesis of the present disclosure can be formed by computer-aided design (CAD) and computer-aided manufacturing (CAM) systems. Additionally, or alternatively, implants, abutments, and prosthesis of this disclosure can be formed with subtractive processes, such as computer numerical control (CNC) milling and/or additive processes, such as 3D printing.

Implants of the present disclosure may have a smooth or rough surface texture. Mechanical surface treatments may be used to significantly alter the topography, while the surface chemistry remains substantially unchanged. Thus, the implants of the present disclosure may be treated to create a suitable roughness of the implant surface giving a mechanical interlocking between bone and implant. Alternatively, or additionally, coating the surface of the implant with certain materials may improve the healing process around the bone-implant (referred to as “osseointegration”). Thus, the implants of the present disclosure may be treated to include a surface coating with materials such as, but not limited to, an artificial hydroxyapatite, bisphosphonate(s), platelet rich plasma (“PRP”) and/or a PRP-bone matrix mix (PRP may be formed by taking a blood sample from the patient, and then centrifuging the blood to create the PRP), or the like. The surface treatment and/or the coating(s) of the implants of the present disclosure may be uniform throughout the external surfaces of the implants, or may be applied to only a portion of the external surfaces of the implants. In specific embodiments of this disclosure, the surface treatment and/or coatings are applied to any portion of the external surface of the implant that will reside below the gum line in the surrounding tissues within the patient's mouth. In specific embodiments of this disclosure, the surface treatment and/or coatings are absent in a portion of the external surface of the implant that will reside above the gum line in the surrounding tissues within the patient's mouth. In specific embodiments of this disclosure, the external surface of the implant that will reside above the gum line in the surrounding tissues within the patient's mouth is smooth and free of surface coatings to form a smooth, hygienic transition area or connection with a dental prosthetic formed on the implant, in an embrasure space in the patient's mouth.

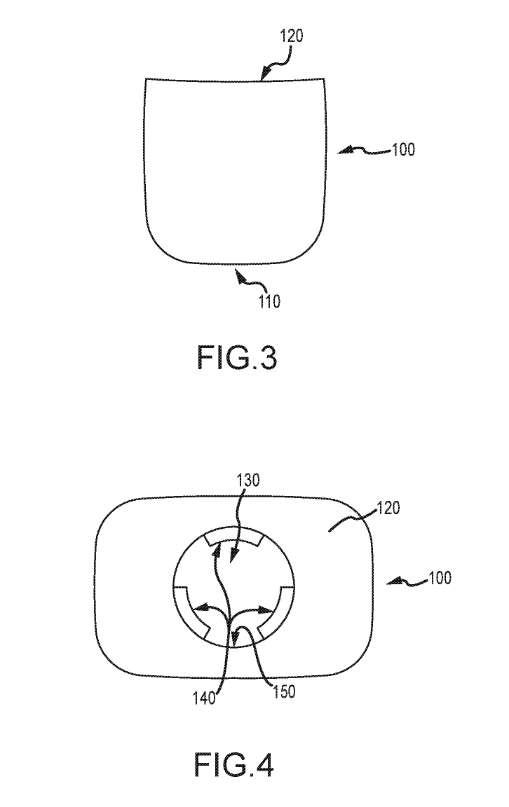

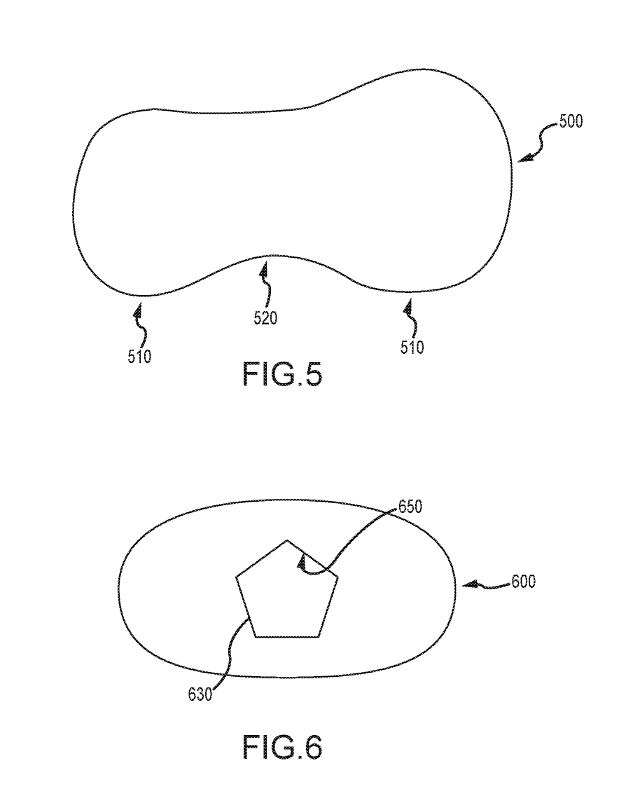

As shown in FIGS. 3 and 4, a dental implant 100 of the present disclosure comprises an apical end 110 adapted to engage a patient's jawbone, a top end 120 opposite the apical end 110, the top end 120 having an abutment or prosthesis receiving portion 130, accessible from the top end 120 of the dental implant 100. The abutment-receiving portion 130 can be adapted to receive a prosthesis, such as a crown or a bridge or other dental fixture, with or without the use of an abutment. Also, an abutment or other device for receiving a crown or other dental fixture may be formed integrally with the implant 100, in which case no abutment receiving-portion 130 is present. The apical end 110 of the implant 100 has a non-cylindrical shape such that, following implantation in the jaw of a patient, the implant will not rotate within the implantation site. In specific embodiments, the apical end 110 of the implant 100 may have a shape substantially consistent with a square, an oval, a rectangle, a pentagon, a hexagon, or the like. In a specific embodiment, the implant as a pentagonal shape. In a specific embodiment shown in the apical view of the implant depicted in FIG. 5, the implant 500 has an hourglass shape in the mesial-distal plane, having two wider portions 510, or lobes, and a narrower center portion 520.

In specific embodiments of the implants of the present disclosure, as depicted in FIG. 4, the abutment-receiving portion of the implant may comprise a cavity 130 formed within the implant 100 to receive an abutment, or other dental prosthetic structure. The abutment-receiving portion 130 of the implant 100 comprises a plurality of projections 140 formed on the interior wall 150 of the cavity comprising the abutment-receiving portion 130 of the implant 100. The projections 140 extend from the interior wall 150 into the cavity comprising the abutment-receiving portion 130 of the implant 100. In specific embodiments, the projections 140 are of a size and/or shape to engage with an abutment in a manner that will prevent rotation of the abutment disposed in the abutment-receiving portion 130 of the implant 100. In specific embodiments, the projections 140 are located about the cavity comprising the abutment receiving portion 130 of the implant 100 in a non-symmetrical pattern that will prevent rotation of an abutment disposed in the abutment-receiving portion 130 of the implant 100. In specific embodiments, the projections 140 comprise both a shape, and a location about the cavity comprising the abutment receiving portion 130 of the implant 100 to prevent the rotation of an abutment disposed in the abutment-receiving portion 130 of the implant 100. Optionally, the projections 140 may be formed in all embodiments of implants of the present invention.

A preferred embodiment is the implant of the present disclosure depicted in FIG. 6. FIG. 6 depicts the top end of an implant, comprising an abutment-receiving portion 630, having a substantially pentagonal shape, which will mate with a corresponding pentagonal abutment, thereby preventing rotation of the abutment disposed in the pentagonally-shaped abutment receiving portion 630 of the implant 600, without the need for specific projections residing on the interior wall 650 of the cavity comprising the abutment receiving portion 630. In related embodiments, the abutment receiving portion of the implant may have a substantially non-cylindrical shape, such as a square, an oval, a rectangle, a hexagon, an hourglass shape, or the like. Optionally, the abutment-receiving portion 630 also include the projections 140 such as generally illustrated in FIG. 4.

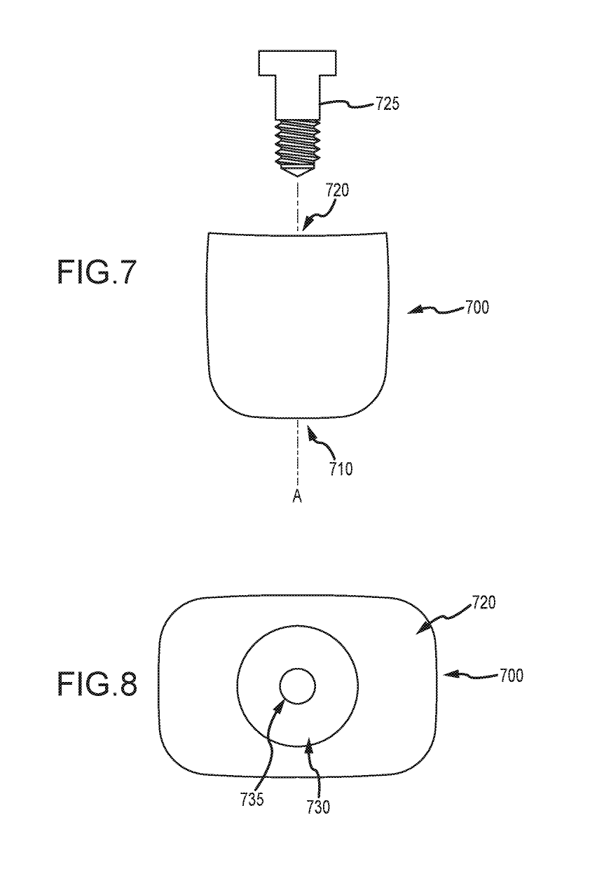

In specific embodiments of the implants of the present disclosure, the abutment-receiving portion of the implant comprises a cavity formed within the implant to receive an abutment, or other dental prosthetic structure, and the cavity further comprises a hole configured for receiving a fixation implant screw that will secure the non-cylindrical implant of the present disclosure into a jawbone of the patient. In one preferred embodiment depicted in FIG. 7, the implant 700 of the present disclosure comprises an apical end 710 adapted to engage the jaw bone of a patient, a top end 720 opposite the apical end 710, the top end 720 having an abutment-receiving portion 730 accessible from the top end 720 of the dental implant 700. The implant 700 has a circular opening 735 in the apical end 710 adapted for receiving a fixation screw 725 that will pass through the abutment-receiving portion 730 and extend below the apical end 710 of the implant 700, along dashed line A, and into the jawbone of the patient to further secure the implant 700 within the jawbone of a patient, while retaining the non-cylindrical, non-rotatable characteristics of the implant 700. Thus, the implant 700 retains the non-cylindrical shape of the implants of some embodiments of the present disclosure such that, following implantation in the jawbone of a patient, including the placement of the fixation screw 725, the implant 700 will not rotate within the implantation site. In one embodiment, the circular hole 735 in the apical end 710 of the implant 700 is a countersunk central opening adapted to fit a countersink head on the fixation screw 725.

FIG. 8 depicts the view of the top end 720 of the implant 700 of FIG. 7. The circular fixation hole 735 can be seen at the bottom of the cavity comprising the abutment-receiving portion 730 in the top end 720 of the implant 700. In this embodiment depicted in FIG. 8, the abutment-receiving portion 730 in the top end 720 of the implant 700 has a substantially circular shape. In one preferred embodiment, the abutment-receiving portion in the top end of the implant 700 has a substantially pentagonal shape. Optionally, the abutment-receiving portion 730 may include inwardly oriented projections 140 that same as, or similar to, the projections described in conjunction with FIG. 4.

### Anatomical Abutment

The present disclosure also provides implant abutments intended to take a dental prosthesis surmounted with a crown, or other dental fixture, cemented, glued, screwed, or otherwise affixed to the abutment, adapted for use with a dental implant of the present disclosure. The abutments of the present disclosure may be made of titanium, zirconium, or the like.

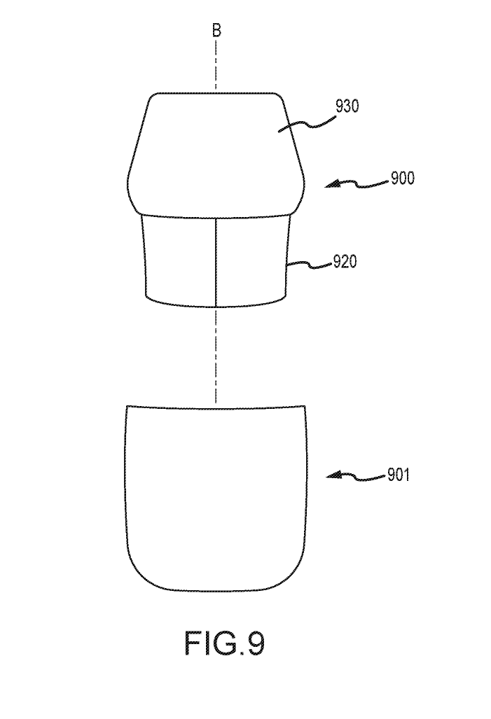

As shown in FIG. 9, an abutment 900 of the present disclosure, which secures a prosthesis to an implant 901 of the present disclosure, includes an implant insertion portion 920 and a prosthesis receiving portion 930. The implant insertion portion 920 of abutment 900 is configured to mate with an abutment-receiving portion of implant 901 of the present disclosure. In one embodiment, the implant insertion portion 920 has a pentagonal shape that will mate with a corresponding pentagonal-shaped abutment-receiving portion of implant 901, when the abutment-receiving portion of the implant 901 is mated with implant insertion portion 920 of abutment 900 along line B.

In specific embodiments, the implant insertion portion 920 may have a shape substantially consistent with a square, an oval, a rectangle, a pentagon, a hexagon, or the like. In a specific embodiment, the implant insertion portion as an hourglass shape. In these embodiments, the abutment-receiving portion of the implant 901 is shaped to receive and mate with an abutment 900 having an implant insertion portion 920 having any one of the shapes described above.

In a specific embodiment of the implant of the present disclosure depicted in FIG. 4, the abutment-receiving portion 130 of the implant 100 comprises a plurality of projections 140 formed on the interior wall 150 of the cavity comprising the abutment-receiving portion 130 of the implant 100. The projections 140 extend from the interior wall 150 into the cavity comprising the abutment-receiving portion 130 of the implant 100. Similarly, in a specific embodiment of the abutment of the present disclosure, the implant insertion portion has a substantially cylindrical shape comprising a plurality of indentations having a size, shape and location configured to mate with the projections 140 formed on the interior wall 150 of the cavity comprising the abutment-receiving portion 130 of the implant 100.

In these embodiments of the abutment of the present disclosure, engaging the abutment receiving portion of the implant with the correspondingly shaped implant insertion portion of the abutment prevents rotation of the abutment disposed in the implant. This also increases the ease of placing the abutment into the implant during the restoration procedure and simplifies the implantation of the dental system for the dental surgeon. Additionally, this configuration, which prevents rotation of the abutment on top of the implant, facilitates immediate restoration of a missing tooth when the abutment is mated with the implant, because the non-cylindrical implant will not rotate in the socket, such that full osseointegration is not necessary and the time to osseointegration is greatly reduced.

In these embodiments of the implants and the abutments of the present disclosure, after the abutment is mated with the implant, the abutment may be secured to the implant by any of the methods well known to those of skill in the art including, for example, cementation, or one or more screws disposed within the interior portion of the abutment and received and secured within the interior portion of the implant. Locking engagement between the complementary shaped surfaces of the implant and the abutment can be achieved through a tapping or threading operation. Some patients find the use of tapping action to seat the abutment onto the implant uncomfortable, and as an alternative, a dental implant system of the present disclosure which utilizes a threaded fastener to seat the abutment onto the implant may be used.

The interlocking non-cylindrical implant and abutment of embodiments of the present disclosure are designed to overcome an aesthetic limitation of the prior art wherein, in many cases, it is possible to see some of the implant between the crown and the gum line. In the use of such prior art devices, patients and dentists often complain about food impacting and accumulating around and beneath the prosthesis portion of the implant in the enlarged periodontal gap between the implant and the adjacent teeth.

Using the non-cylindrical implants of embodiments of the present disclosure (which are generally wider and provide better anatomical fit than implants and abutments of the prior art) allows for a more anatomical emergence profile than is often available with prior art reconstruction systems. The broader top of the dental implants of the present disclosure allows for a more anatomical emergence profile than is often available with prior art reconstructions systems, and this enhances the aesthetic appearance of the reconstruction, and avoids many hygienic problems, as well as the accumulation of food in the periodontal gap, as described above. The wider implant and matching abutment of the present disclosure better distributes load on the jawbone, thereby allowing the prosthesis to have more upright peripheral sidewalls, so that embrasures, or periodontal gaps, between the bottom portion of the crown and adjacent teeth are substantially reduced, and so that both food impaction and collection are also substantially reduced. The matching abutment of the present disclosure also provides a smooth transition between the prosthesis and the implant fixture, which results in good soft tissue adaptation.

### Dental Implant Procedure

This disclosure also provides a dental implant process that reduces surgical time and the cost of an implant operation, resulting in the formation of a restoration with a wider, anatomical implant shape having a more ideal emergence profile, providing better support for crowns, especially ceramic crowns, and improved hygienic embrasure spaces. The dental implant processes of the present disclosure reduce the time period that is customarily required between tooth extraction and the placement of a false tooth or prosthesis on the implants of the present disclosure. Additionally, these dental implant processes of the present disclosure may allow the implant to be inserted or set within the tooth cavity immediately after extraction.

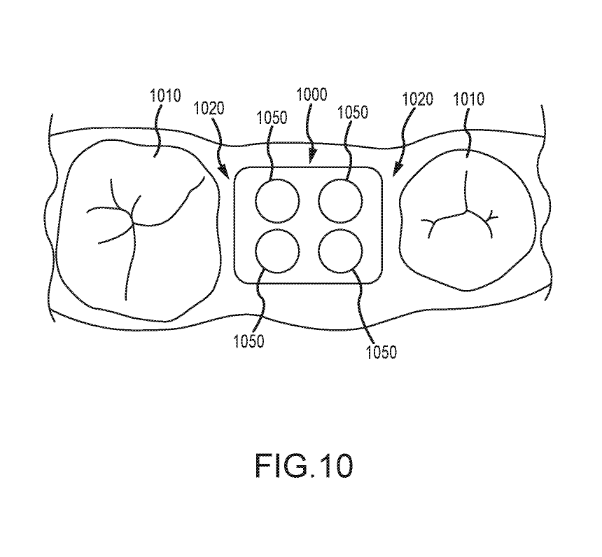

The dental implant procedures of the present disclosure generally include the following steps. Initially, the restoration site is identified and cleaned and sufficient gum is removed from the jawbone to allow an implant of the present disclosure to seat directly on the exposed jawbone. In one embodiment, placing the implant in the jawbone includes first drilling one or more pilot holes in the jawbone, removing additional gum from the jawbone, as needed. A surgical drill guide can be secured about the extraction site to guide the formation of drill holes. FIG. 10 depicts a surgical drill guide 1000 of the present disclosure located at the apical surface of a patient's gum 1020 at an extraction site, between two natural teeth 1010. The surgical drill guide 1000 includes a plurality of holes 1050 of various sizes and spatial arrangements that will guide a dental drill into the jawbone to form patterns of drill holes, or pilot holes, which may be positioned and enlarged to accept an implant of the present disclosure. Once the pilot holes have been created using the surgical drill guide, in one embodiment, the dental surgeon prepares an eccentric site for accepting the implant using an osteotome to expand the extraction cavity to fit the chosen implant. The implant cavity is reamed to shape and contour the extraction cavity to accept the selected implant.

After reaming and forming a clean and open implant cavity, an implant of the present disclosure is firmly set into the reamed extraction cavity. Optionally, the implant of the present disclosure may be anchored within the alveolar bone using a fixation screw extending from the apical end of the non-cylindrical implant, as described above. The implant may be a non-cylindrical implant of the present disclosure. Alternatively, a cylindrical implant of the present disclosure can be anchored in the implant cavity.

After the implant has been set, the implant site may be closed in order to heal the site for a period of time. A temporary cap can be used, but in most cases it is preferred that the gingival flap be returned across the top of the implant so as to close the implant site. Thereafter, a process of osseointegration occurs, wherein the bone structure remodels and heals in intimate contact with the implant. The time for healing can vary from approximately 3 to 12 months depending on the age of the patient and other factors. After integration has been achieved, the dental professional can then secure a false tooth or other dental prosthesis to the top of the implant.

After osseointegration occurs, the gum around the implant disposed in the jawbone is positioned and maintained. A dental prosthesis is modeled in a form sized to fit on the implant or an abutment attached to the implant. The prosthesis is sized and formed to appropriately fill the open space between the adjacent teeth. Finally, the molded prosthesis is affixed to the implant of the present disclosure, which is anchored in the jawbone of the patient.

In some instances, an impression can be taken and the prosthetic device made prior to installation of the dental implant. In such cases, a non-cylindrical implant of the present disclosure and the appropriate prosthetic device can be installed in the same visit. In cases where the prosthetic device is to be installed in a visit subsequent to installation of the implant, a temporary prosthetic device (e.g., a conventional temporary cap) may be installed using a cement to temporarily secure the temporary cap to the dental implant. It is postulated that in the instance where implanting takes place immediately after extraction, there is quicker healing and osseointegration because the alveolar bone has not been subjected to the trauma of drilling that takes place in cases where the implanted site has healed and closed.

Although the steps described above are presented in a specific order, the technology presented herein can be performed in any variation of this order. Furthermore, additional steps may be executed between the steps described above. One or more steps may also be omitted during a dental implant procedure of the present disclosure.

### Impression Coping and Related Materials and Kits and Methods of Using the Same

In dental implant procedures, an impression coping (also referred to as a transfer coping) is attached to the implant, or an abutment attached to the implant, to transfer the position of the implant in the patient to a working model, which is used in a dental laboratory where the permanent dental prosthesis is prepared.

During the surgical procedure, the impression coping is attached to the implant or abutment while the impression is made. This attachment is typically made with a separate securing screw, which attaches to internal threading on the implant to hold the impression coping in place on the implant. An impression of the patient's dental structure surrounding the site of the implant is then made using an impression material, such as a polymeric material. The impression material is then removed and sent to a dental laboratory, where the permanent dental prosthesis is fabricated. In this way, the ultimate position of the implant in the patient's mouth is identified and set by the position of the impression coping within the impression material.

Conventional open and closed tray techniques both use screws to secure the impression coping to the implant. In the closed tray technique of making dental impressions, the impression coping is engaged with the implant or abutment using the securing screw and an impression material is injected around the coping. The impression is then removed, leaving the impression coping in place. This limits the accuracy of the model of the patient's dentitia based on the impression as the impression coping must be reassembled, and the impression sent to the dental laboratory, such that the impression coping may not be properly re-oriented into the impression after removal from the patient's mouth.

Conversely, in open tray techniques, the securing screw is loosened and the impression coping is picked up with the impression material as the material is removed. This technique may also lead to inaccuracies in the model of the patient's dentitia because the angle and height of the impression coping may be altered when the screw is loosened/removed prior to removal of the impression material from the patient's mouth.

Accuracy in the location of the impression coping (particularly height and angle) within the impression is important to ensure that the prepared prosthesis fits properly in the implant and relative to the patient's existing teeth and gumline. Failure to accurately position the prosthesis could result in patient discomfort and/or failure of the restoration or implant. Thus, there is a need for an impression coping that may accurately and reliably identify the position of dental implants in patients. Moreover, there is a need for an impression coping that facilitates the impression process, requiring less manipulation by a dentist or dental technician, and that reduces the chances of having to retro-fit the impression coping back into the impression material after removal from the implant.

The present disclosure provides an impression coping that can be used to identify the position of an implant in a patient. The impression coping according to various embodiments of the present disclosure may attach to an implant or abutment, such as a dental implant, without the use of a screw. In other embodiments, the impression coping according to various embodiments of the present disclosure may be secured to an implant or abutment using a screw. In at least one embodiment, the impression coping may be an implant level impression coping, which may allow the impression coping to be used without an abutment.

Impression copings in accordance with various embodiments of the present disclosure also may comprise an impression material contact portion. Once the impression coping is attached to the dental implant, an impression can be taken, for example with a closed dental tray, well known to those of skill in the art. The impression material surrounds the impression material contact portion of the impression coping and securely attaches the impression to the impression coping once the impression material has cured.

The impression coping according to embodiments of the present disclosure may comprise a material chosen from metal, ceramic, plastic (which may be disposable), and/or combinations thereof. In at least one exemplary embodiment, the impression coping comprises a material chosen from stainless steel, titanium, and titanium alloys. In at least one embodiment of the present disclosure, the impression coping comprises a material that is radiopaque. A radiopaque impression coping may be observable using an X-ray, which may aid in locating the implant in the patient's mouth and the position of the impression coping in the impression, and/or aid in the confirmation of the engagement between the dental implant and the impression coping.

After the impression material has cured, the impression material, with the impression coping attached or embedded therein, is removed. The impression material and the impression coping may be removed by pulling the impression coping off the dental implant, by moving the impression coping in a direction generally along the longitudinal axis of the dental implant and away from the dental implant. The impression may then be sent to a dental laboratory where the permanent tooth is fabricated.

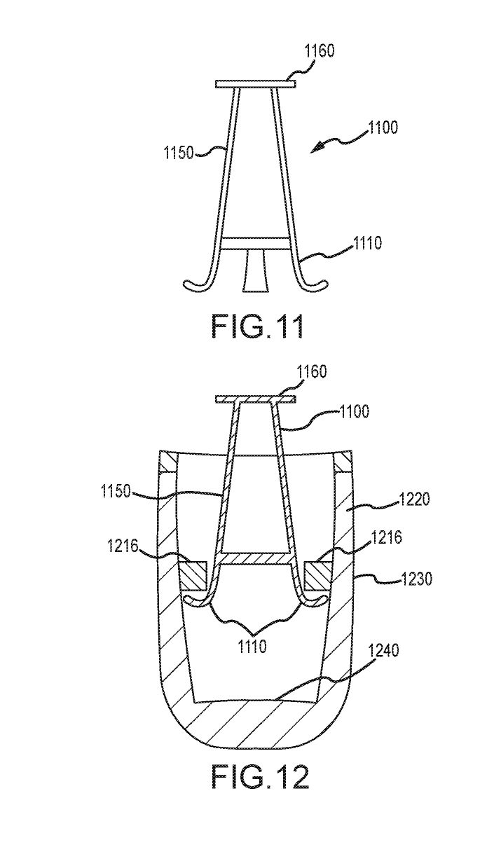

An impression coping according to one embodiment of the present disclosure is illustrated in FIG. 11. In FIG. 11 the impression coping 1100 comprises an implant mating portion 1110 and an impression material contact portion 1150, and a top 1160. The impression material contact portion 1150 is generally cylindrical. In some embodiments, impression material contact portion 1150 further comprises projections or surface texturing, roughening and/or other surface features, and/or other configurations to enhance contact and retention in an impression material. Those having ordinary skill in the art will readily understand that the configuration of such projections or surface treatments may be utilized without departing from the scope of the present disclosure.

As shown in FIG. 11, the impression coping 1100 is configured with an implant mating portion 1110 configured to be received by, and mate with, an implant. In accordance with various embodiments, the implant mating portion 1110 may be configured to engage with the interior portion of a variety of implants, including, for example, the various implants of the present disclosure described herein, including any dental implant with an indented feature, such as a groove or ledge, configured to permit a mating fit (e.g., snap-fit) with a cooperating protrusion, such as the implant mating portion 1110 of the impression coping of FIG. 11.

As depicted in FIG. 11, the implant mating portion 1110 comprises a plurality of flanges 1110 situated around the base of impression material contact portion 1150, opposite the top 1160. Flanges 1110 may be spaced regularly around the generally cylindrical impression material contact portion 1150. Flanges 1110 are configured to engage with implants having openings that hook or retain the flanges to provide an anti-rotational engagement of the impression coping with the implant. For example, FIG. 12 shows a partial cross-section of the impression coping 1100 of FIG. 11 engaged with a dental implant 1220 set in the jawbone 1230 of a patient.

As noted above, impression coping 1100 comprises a plurality of flanges 1110 situated around the base of impression material contact portion 1150. Implant 1220 includes a plurality of protrusions 1216. As shown in FIG. 12, the protrusions 1216 matingly-engage flanges 1110 on the impression coping 1100. In at least one embodiment, a snap-fit engagement may be possible by positioning and sizing the protrusions 1216 in a way that they contact flanges 1110 on the impression coping 1100 and elastically deflect the flanges 1110. Once the flanges 1110 extend beneath protrusions 1216 as the impression coping 1100 is seated in the implant 1220, the flanges 1116 spring back to their undeflected state. An audible sound may be produced when the flanges 1116 spring back to their undeflected state, which may provide an indication that the impression coping 1100 has been properly seated in the implant 1220. The impression coping 1100 is held properly seated in the implant 1220.

Conventional dental implants generally comprise a threaded exterior portion that attaches to the jawbone of a patient and interior threads designed to receive restorations or other fixtures, such as an impression coping. Those of skill in the art would be familiar with the various conventional dental implant configurations and features useful with the transfer copings of the present teachings. Similar to a conventional implant with internal threading, in at least one embodiment of the present disclosure, the implant 1220 may contain internal threading that allows a securing screw to pass through impression coping top 1160 and engage threads near the base 1240 of implant 1220. Thus, a related embodiment of the disclosure is an impression coping securing screw for securing an impression coping to an implant. The impression coping securing screw may be made of metal or other suitable hard material, while the threads of the impression coping securing screw are made of a heat labile plastic, or silicone.

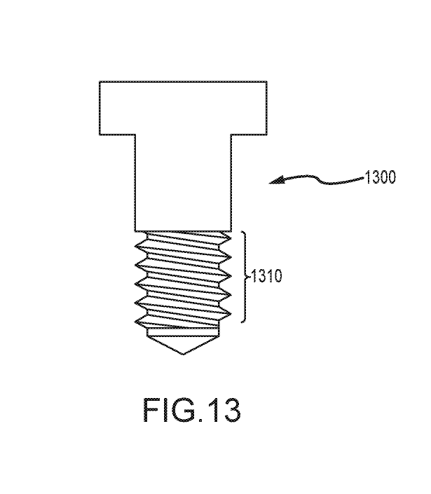

One such impression coping securing screw 1300 of this disclosure is depicted in FIG. 13. Threads 1310 may be composed of a heat labile plastic, or silicone. In related embodiments, threads 1310 may be made of metal or other suitable hard material, and coated with a heat labile plastic, or silicone. In use, the impression coping securing screw 1300 is threaded into the internal threading in a dental implant by exerting a rotational force on the impression coping securing screw. At the time of removal, the heat labile plastic, or silicone (or heat labile plastic, or silicone-coated threads) are activated to allow the impression coping secured by the impression coping securing screw 1300 to be disengaged from the implant and removed with the impression of the patient's dentitia.

Another embodiment of the present disclosure is a dental implant system comprising an implant member, an impression coping member, and an impression coping securing screw comprising a heat labile plastic, or silicone (or heat labile plastic, or silicone-coated threads) configured to cooperatively engage the implant and the impression coping structures for ensuring proper alignment and orientation of an abutment or other dental prosthesis assembled on the implant and for preparing an accurate dental impression and mold which represents the implantation site and its relationship to adjacent teeth structures.

Another embodiment of the present disclosure is a method of impression making and dental reconstruction utilizing the components of the dental implant system of the present disclosure. In at least one such embodiment, an impression coping includes a screw access channel in the impression coping to allow a dental professional to use an impression coping securing screw to secure the impression coping onto a dental implant, followed by removal of the impression coping securing screw at the time of removing the impression. In a specific embodiment, the impression coping securing screw is removed immediately after the threaded portion of the impression coping securing screw comprising a heat liable plastic or silicone is activated to dissolve or soften sufficiently to allow the removal of the impression coping securing screw from the implant without unscrewing the impression coping securing screw.

Another embodiment of the present disclosure provides a method for obtaining an accurate translation of an orientation and position of an implant. With reference to FIG. 12, one embodiment of this method comprises providing a dental implant of this disclosure, having a plurality of protrusions 1216 internal to an interior cavity of the implant, which protrusions 1216 matingly engage flanges 1110 on an impression coping 1100 in a snap-fit engagement when the flanges 1110 extend beneath protrusions 1216 as the impression coping 1100 is seated in the implant 1220, the flanges 1116 spring back to their undeflected state, which may produce an audible sound indicating that the impression coping 1100 has been properly seated in the implant 1220. In a preferred embodiment, a bore extends through the impression coping 1100, allowing the passage of an impression coping securing screw through the impression coping 1100, seating the impression coping onto the implant, and engaging corresponding threading in the internal cavity of the implant in a closely fitted engagement. The impression coping securing screw comprises heat labile plastic, or silicone (or heat labile plastic, or silicone-coated threads) configured to cooperatively engage the implant. A dental impression material is then applied to at least an area adjacent the impression coping so as to cover the impression coping to obtain a negative impression of the area.

After the impression material has set, the heat labile plastic or silicone portion of the impression coping securing screw is then activated to dissolve or soften sufficiently to allow the removal of the impression coping securing screw from the implant without unscrewing the impression coping securing screw, and then the impression material is removed from the patient's mouth with the impression coping embedded in the impression material. The impression material, including the impression coping, may be sent to a dental lab, where a molding material is poured into the negative impression formed in the impression material to form a dental cast model, and a dental prosthetic is fabricated on an implant analog to match the surrounding dentitia of the patient. This method accurately positions the dental implant installed in the patient's mouth, based on the model created in the method described above, however, it will be apparent to one of ordinary skill in the art that other embodiments, or variations on this methodology are also possible in which various steps are added, combined, modified, substituted, automated or omitted.

To simplify impressions for both dentist and patient, a special impression coping screw would be utilized. This impression method is used instead of currently-available impression coping methods wherein the impression coping is screwed in and must either be unscrewed prior to removing the impression (open-tray method, which is considered more accurate), or after removing the impression, the impression coping is re-inserted into the impression (closed-tray method).

This new impression coping method of this disclosure is easier for the dentist and more comfortable for the patient. The impression coping is shorter in height which creates a more stable platform when taking impressions. It is further stabilized by screwing it into the internal part of the implant. By using a screw that is metal with flexible or heat labile plastic threads that are large enough to be screwed into the implant, but are able to be pulled out without much force, the impression coping is then used in a closed tray method, which is easier for the dentist and more comfortable for the patient. But the dentist would have the benefit of accuracy of the traditional open-tray method in which the implant coping is unscrewed prior to impression removal. The threading and/or sleeve coating of the impression coping securing screw is preferably a plastic or silicone material with enough flexibility to be pulled out of the implant with low resistance such that it is not difficult for the dental professional and does not cause pain or stress to the patient. The head and body of the screw may be made of titanium or a rigid but less expensive material. In one embodiment, the impression coping securing screw having a heat labile or pliable material is configured as a single-use product, which is more hygienic and safer for the patient. In this embodiment, the metal or hard plastic portions of the impression coping securing screw could be re-sterilized and reused after association with the heat labile or pliable material.

### Dental Implant System Kit

Another aspect of the present disclosure provides a multi-component dental implant system comprising at least one dental implant and an implant abutment of the present disclosure, with the at least one implant and the abutment being configured to detachably join to one another with an improved assembly designed to prevent rotation of the abutment about the implant. The implant is one of non-cylindrical and cylindrical.

In one embodiment, the multi-component dental implant systems of the present disclosure may include an implant comprising an abutment-receiving portion which will mate with a corresponding implant insertion portion of an abutment thereby preventing rotation of the abutment disposed in the abutment receiving portion of the implant. In one embodiment, the abutment-receiving portion can have a substantially pentagonal shape which will mate with a corresponding pentagonal shaped implant insertion portion of the abutment, thereby preventing rotation of the abutment disposed in the pentagonally-shaped abutment receiving portion of the implant. In related embodiments, the abutment receiving portion of the implant(s) in the multi-component dental implant systems of the present disclosure may have a substantially non-cylindrical shape, such as a square, an oval, a rectangle, a hexagon, an hourglass shape, or the like.

The multi-component dental implant system of the present disclosure may further include a set of standard shaped devices and standard surgical tools prepared for the dental professional to choose from. For example, the dental implant system may have variously shaped cylindrical and non-cylindrical implants configured to replace bicuspids, molars, canines, and incisors, and different sizes for each shape. From this dental implant system, the dental professional chooses the parts that are appropriate for the particular restoration.

As an alternative, the dental professional may have the prostheses portions custom made, after analyzing the patient. In this alternative embodiment, the professional may have the prostheses prepared with the aid of a CAD-CAM system which may include the use of a milling machine or powder metallurgy (or other forms of additive manufacturing process, such as 3D printing), among other known methods of forming parts. As examples of how to select the proper parts, the parts may be matched to the shape of an extracted tooth, if one is available, or to an impression of the teeth and gums surrounding the site of the implant. In one embodiment of the multi-component dental implant system of the present disclosure, it is contemplated that a series of differently sized, standard implants would be available. Such a kit of standard, non-cylindrical implants may vary in length and shape. Once the appropriate implant has been selected from the group of standard implants, the dental professional selects corresponding or matching surgical tools, including, for example, a surgical drill guide, a reamer from a reamer set, conventional drill bits from a set of drill bits used in dentistry for the installation of dental implants, a surgical fixation screw(s), bone screw insertion tool(s), a healing abutment that need not be removed during an impression taking procedure, and an implant coding system that facilitates selection and identification of a non-cylindrical dental implant of the present disclosure. Thus, the multi-component dental implant system of the present disclosure may include any one or all of these additional restoration components and/or surgical tools or subsets or combinations thereof, that useful in practicing the methods of the present disclosure.

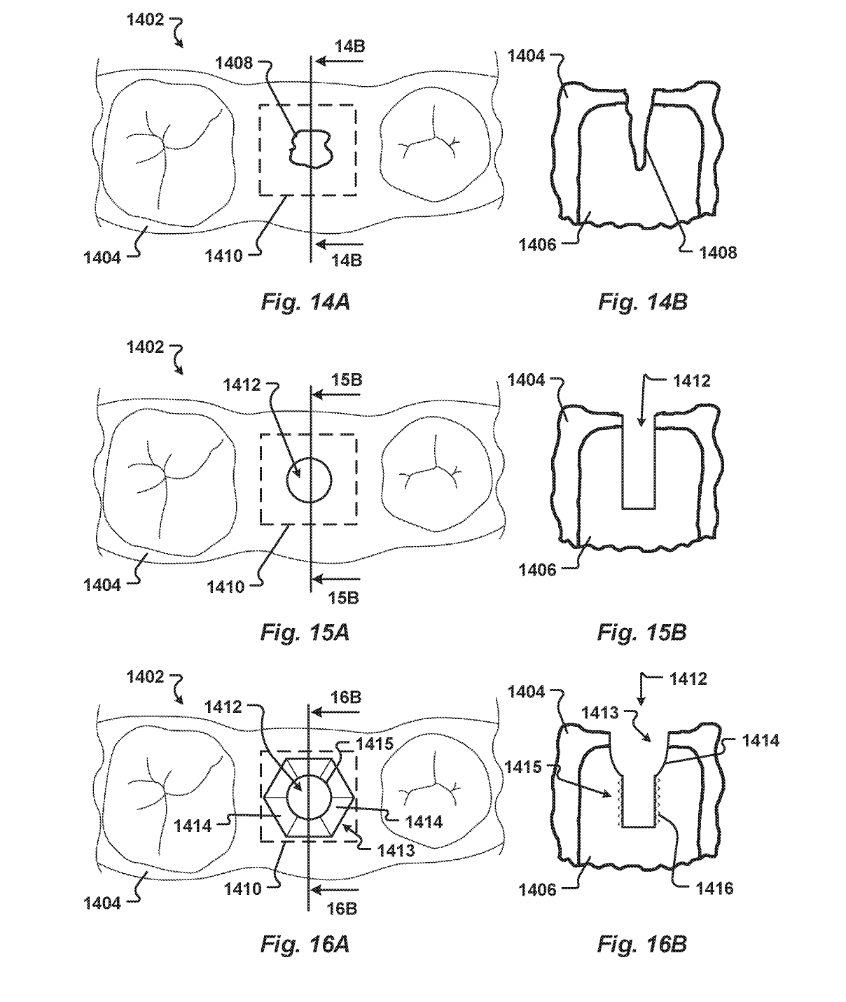

Referring now to FIG. 14A-14B, an implant site 1410 of a patient's jaw 1402 is generally illustrated. The implant site 1410 can be used for implanting a dental implant or Unplant system 1420 of the present disclosure for any tooth, such as an incisor, a canine, a bicuspid, or a molar. In some embodiments, the implant site 1410 can be a fresh extraction site from which a tooth has been removed, a molar extraction site, a healed ridge or healed extraction site, or other site along the jaw 1402. As such, the implant site can comprise one or more root sockets 1408 which generally remain exposed after a tooth has been removed. The root socket 1408 may be positioned between two natural teeth. As shown in FIG. 14B, the root socket 1408 extends through gum tissue 1404 into bone tissue 1406, such as alveolar bone.

As generally illustrated in FIGS. 15A-15B, the implant site 1410 is cleaned to form an implant cavity 1412 to receive a first stage implant 1422 of the present disclosure. Forming the implant cavity 1412 can include removing some of the bone tissue 1406 at the implant site 1410. The bone tissue can be removed by reaming, drilling, and the like. The implant cavity may be formed in the patient's jaw 1402 using the methods and apparatus described in U.S. Pat. No. 9,259,299, U.S. Pat. No. 9,463,078, and U.S. Pat. No. 9,615,894 which are each incorporated herein by reference in their entirety.

The implant cavity 1412 has a predetermined geometric profile configured to receive a first stage implant 1422. In one embodiment, the implant cavity has a generally cylindrical shape. Other shapes are contemplated. For example, in one embodiment, the implant cavity is tapered and includes a larger diameter at a coronal end proximate to the gum tissue 1404 and a smaller diameter at an apical end. Thus, the implant cavity can have a shape similar to a conical frustum. A bottom portion of the implant cavity may be rounded or generally planar as illustrated.

Optionally, the implant cavity 1412 has a diameter of up to about 14 mm when replacing a molar. The implant cavity can have a depth that is greater than the depth of the root socket 1408. In this manner, the implant cavity 1412 can extend into healthy bone tissue or bone tissue with a predetermine density. In one embodiment, the implant cavity has a depth of between about up to about 22 mm. As one of skill in the art will appreciate, the dimensions of the implant cavity, including the diameter, depth, and angular orientation will vary from patient to patient as well as which tooth is associated with the implant site 1410.

A coronal or upper portion 1413 of the implant cavity 1412 may subsequently be expanded. Specifically, and referring now to FIGS. 16A-16B, additional bone tissue 1406 can be removed at the implant site to expand the upper portion 1413 of the implant cavity. The upper portion 1413 of the implant cavity can be shaped to substantially conform to a second stage implant 1450 having an anatomical emergence profile for a molar or other tooth which is being replaced at the implant site 1410. Accordingly, the geometric profile of the cavity upper portion 1413 will vary depending on the location of the implant site 1410.

In one embodiment, the upper portion 1413 of the implant cavity 1412 is configured to prevent rotation of a second stage implant 1450 with respect to the jaw 1402. More specifically, in one embodiment, the upper portion 1413 has a shape selected to lock the second stage implant 1450 in place. Optionally, the cavity upper portion 1413 may have a shape that is not round. For example, as generally illustrated in FIG. 16A, the upper portion 1413 can include at least two sides 1414. In one embodiment, the upper portion 1413 has a shape that is generally hexagonal. Although the sides 1414 of the cavity upper portion 1413 are illustrated in FIG. 16A as being generally symmetrical and having substantially the same lengths, in other embodiments of the present disclosure the sides of the cavity upper portion may have variable lengths or shapes. Additionally, the sides 1414 may intersect at different angles. Accordingly, in one embodiment, the upper portion 1413 forms an irregular polygon, such as an irregular hexagon.

Optionally, threads 1416 can be formed in the bone tissue 1406 in a lower portion 1415 of the implant cavity 1412. The threads 1416 can be adapted to engage threads 1432 of a first stage implant 1422. The threads may have any pitch, thread count, or geometry configured to substantially conform to the threads 1432 of the first stage implant.

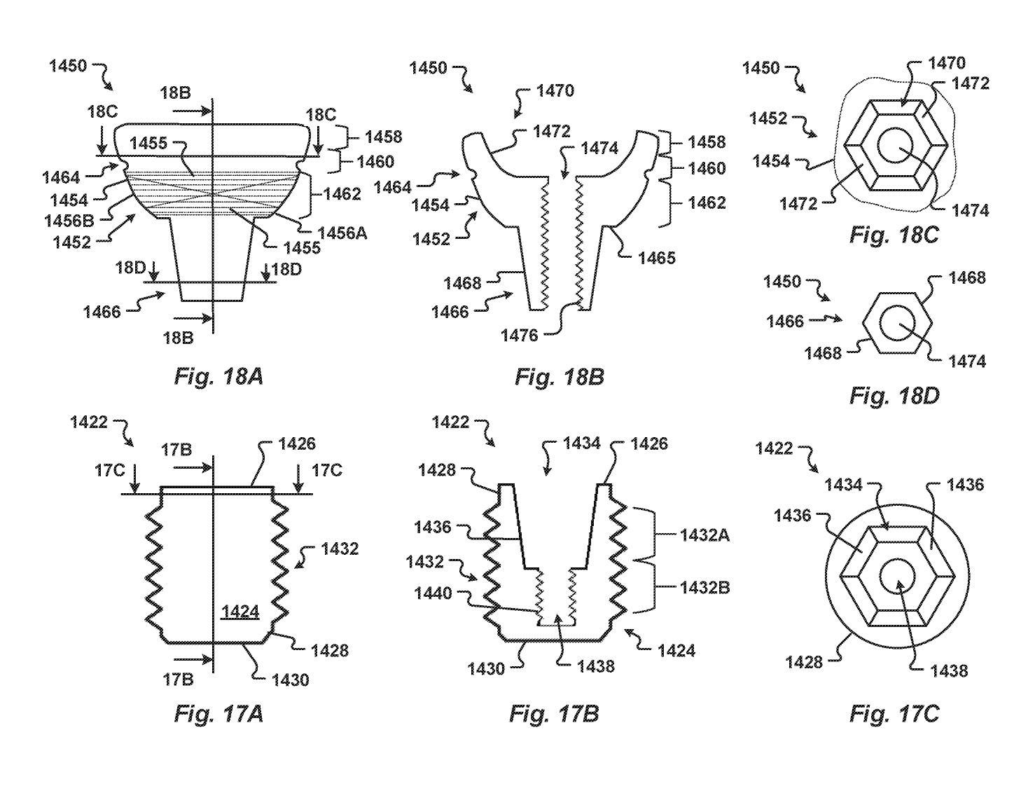

Referring now to FIGS. 17A-17C, a first stage implant 1422 of one embodiment of the present disclosure is generally illustrated. The first stage implant 1422 is configured to fit into a lower portion 1415 of an implant cavity 1412 formed in a patient's jaw. More specifically, the first stage implant 1422 is configured to be positioned in the jaw 1402 below the crest of the bone tissue. In this manner, threads 1432 formed on the first stage implant are not exposed above the crest of the jaw bone tissue 1406. The first stage implant has a body 1424 with a sidewall 1428. In one embodiment, the sidewall 1428 is generally cylindrical. In another embodiment, the sidewall 1428 is tapered. Thus, the implant body 1424 can have a shape of a conical frustum. Optionally, the sidewall 1428 is tapered at an angle of between about 0.1° and about 12.0°. In another embodiment, the implant sidewall is tapered at an angle to form a Morse taper known to those of skill in the art.

Threads 1432 are formed on the sidewall 1428. The threads 1432 may be configured to engage threads 1416 optionally formed in the lower portion 1415 of the implant cavity. The threads 1432 can have any geometry and pitch. Further, the geometry, pitch, diameter, and number of the threads 1432 may change along the length of the first stage body 1424. For example, a coronal or upper portion of the body may have threads 1432A that are different from threads 1432B formed on an apical or lower portion of the body 1424. In one embodiment, the upper threads 1432A are finer to engage cortical bone. Additionally, or alternatively, the lower threads 1432B may be coarser to engage the cancellous bone of the jaw.

Additionally, or alternatively, in one embodiment, the thread depth of the upper threads 1432A can be shallower than the thread depth of the lower threads 1432B of the first stage implant 1422. In one embodiment, the lower threads 11432B can have a thread depth from about 50% to about 100% greater than the upper threads 1432A. in other words, the ratio of the lower threads to the upper threads ranges from about 1.5 to about 2. The greater thread depth of the lower threads 1432B facilitates deeper penetration into the cancellous bone of the jaw 1402, which allows more surface area from the lower threads 1432B to engage the cancellous bone, thereby forming a more stable connection as compared to shallow threads.

Optionally, in one embodiment of the present disclosure, the thread depth of the upper threads 1432A is between about 0.2 to about 0.15 mm. The thread depth of the lower threads 1432B can be between about 0.6 to about 0.7 mm. In one embodiment, the diameter of the upper portion of the implant is up to about 4.3 mm. Other depths and geometries of the threads 1432A, 1432B are contemplated.

The upper threads 1432A may include a different number of threads than the lower threads 1432B. In one embodiment, the upper threads 1432A include up to four leads or threads. Optionally, in another embodiment, the lower threads 1432B include one or two leads or threads. The threads 1432 may have the geometry and/or the dimensions of one or more of the dental implants described in U.S. Pat. No. 6,527,554, U.S. Pat. No. 8,038,442, U.S. Pat. No. 8,241,036, U.S. Pat. No. 8,721,335, and U.S. Pat. No. 8,758,012 which are each incorporated herein by reference in their entirety.

The hardness of the implant body 1424 may also vary along the length of the first stage implant. For example, the first stage implant 1422 may be formed to have different hardness's based on the hardness and structure of bone tissue at the implant site. Methods of producing implants with different hardness's are described in U.S. Pat. No. 9,737,392 which is incorporated herein by reference in its entirety.

A distal or apical end 1430 of the body 1424 may be generally planar. Alternatively, the apical end 1430 may be rounded or have a conical shape. In one embodiment, the apical end 1430 is concave or convex. In one embodiment, the distal end 1430 has a diameter of between about 2 mm and about 5 mm.

A chamber 1434 is formed in a coronal or upper end 1426 of the implant body 1424. The chamber 1434 is configured to receive an extension 1466 of a second stage implant 1450. The chamber 1434 can have one or more interior walls 1436. In one embodiment, the chamber 1434 has up to eight interior walls. In another embodiment, the chamber has six interior walls 1436 and is generally hexagonal. Although the interior walls 1436 illustrated in FIG. 17C form a regular hexagon, other shapes are contemplated. In one embodiment, each of the interior walls 1436 has substantially the same size and shape. Alternatively, at least one of the interior walls 1436 has a different size or shape. For example, one of the interior walls 1436 may have a different width compared to another interior wall. Accordingly, in one embodiment, the interior walls 1436 can form an irregular polygon, such as an irregular hexagon or an irregular pentagon.

The interior walls 1436 may be approximately parallel to a longitudinal axis of the first stage implant 1422. Alternatively, one or more of the interior walls 1436 may be angled relative to the implant longitudinal axis. Accordingly, in one embodiment, the chamber 1434 has a shape of a hexagonal frustum. In one embodiment, the interior walls are angled at an angle of between about 0.1° and about 12.0° to the longitudinal axis. In another embodiment, the chamber interior walls 1436 are tapered at an angle to form a Morse taper.

One or more projections (not illustrated) may extend into the chamber 1434. The projections may be the same as, or similar to, the projections 140 described in conjunction with FIG. 4.

A cylindrical bore 1438 may be formed in the first stage implant 1422. The cylindrical bore 1438 can be positioned within (or extend from) the chamber 1434. The cylindrical bore 1438 is adapted to receive a threaded fastener 1480. In one embodiment, the cylindrical bore 1438 has threads 1440 configured to engage threads 1482 of the threaded fastener 1480. Optionally, the cylindrical bore 1438 is generally concentrically aligned with the longitudinal axis of the first stage implant 1422. In one embodiment, the cylindrical bore 1438 does not extend through the body apical end 1430. Alternatively, in another embodiment, the cylindrical bore 1438 extends through the apical end 1430 or the sidewall 1428 of the body.

The apical end 1430 and sidewall 1428 of the first stage implant 1.422 can be configured to promote osseointegration. For example, the apical end and sidewall may be treated to have an increased surface area configured to promote osseointegration. In one embodiment, the apical end 1430 and sidewall 1428 can be roughened in several different ways, including one or more of acid-etching, grit blasting, and machining. Additionally, or alternatively, the apical end 1430 and/or sidewall 1428 may be coated with a substance in order to promote osseointegration. In one embodiment, calcium phosphate ceramics can be added to the implant body 1424 to enhance osseointegration by changing the chemistry of the apical end and/or sidewall. The calcium phosphate ceramics may include tricalcium phosphate (TCP) and hydroxyapatite (HA). In another embodiment, macroscopic structures can be formed on the apical end 1430 and sidewall 1428 including, but not limited to, threads, micro-threads, indentations, pores, and/or grooves that are configured to promote osseointegration. In another embodiment, one or more of the apical end 1430 and sidewall 1428 comprises a microstructure surface, such as a highly crystalline and phosphate enriched titanium oxide micro-structured surface with open pores in the low micrometer range. In yet another embodiment, the body 1424 is formed of zirconium ceramic and is coated with porous zirconium to provide a microstructure surface. Optionally, at least the threads 1432 of the body 1424 are coated with a porous layer. In one embodiment, a bone growth stimulating substance can be positioned within pores of the porous layer or coating. One or more of the osseointegration features and techniques can be added to the body 1424.

Referring now to FIGS. 18A-18D, a second stage implant 1450 of one embodiment of the present disclosure is generally illustrated. The second stage implant 1450 generally includes an abutment 1452 with an extension 1466.

The extension 1466 is adapted to be received within the chamber 1434 of the first stage implant 1422. Accordingly, the extension 1466 has a shape and size configured to substantially conform to the chamber 1434. The extension 1466 and chamber 1434 have geometries selected to prevent rotation of the second stage implant 1450 relative to the first stage implant 1422.

In one embodiment, the extension 1466 includes one or more exterior walls 1468. More specifically, the extension 1466 may include one or more exterior walls 1468 which are each configured to contact a corresponding interior wall 1436 of the first stage implant 1422. In one embodiment, the extension has up to eight exterior walls 1468.

The exterior walls 1468 may optionally be substantially parallel to a longitudinal axis of the second stage implant. Alternatively, one or more of the exterior walls 1468 may be angled or tapered relative to the longitudinal axis to correspond to a taper of the chamber 1434 of the first stage implant.

In one embodiment, each of the exterior walls 1468 has the same size and shape. Accordingly, each of the exterior walls 1468 can be aligned with any interior wall 1436 of the first stage implant. Thus, the second stage implant 1450 can have several orientations in which the extension 1466 can be received in the chamber 1434 of the first stage implant. Alternatively, each exterior wall 1468 can be configured to align with only one of the interior walls 1436. In this manner, the second stage implant 1450 can have only one orientation with respect to the first stage implant.

In one embodiment, the extension 1466 includes one or more grooves (not illustrated). The groove are adapted to receive projections 140 formed within the chamber 1434 of the first stage implant. Additionally, or alternatively, the extension 1466 may optionally include a projection extending outwardly from an exterior wall 1468. The projection may be similar to the projections 140. The chamber 1434 may have a recess configured to receive the outwardly extending projection of the extension 1466. The interaction of the grooves and the projections is configured to prevent unintended, or inadvertent, rotation of the second stage implant 1450 relative to the first stage implant.

The abutment 1452 of the second stage implant 1450 is configured to substantially conform to an upper portion 1413 of an implant cavity 1412 formed in a patient's jaw 1402. In one embodiment, an exterior surface 1454 of the abutment 1452 has a shape selected to prevent unintended or inadvertent movement of the second stage implant 1450 with respect to the implant cavity 1412. Optionally, the exterior surface 1454 of the abutment 1452 has a shape that is not symmetric relative to the longitudinal axis of the second stage implant. In another embodiment, the exterior surface 1454 comprises an irregular shape.

In one embodiment, the exterior surface 1454 includes at least two faces 1456. In one embodiment, the abutment exterior surface includes three or more faces 1456. In another embodiment, the abutment 1452 has three to six faces and has a shape that is generally triangular, rectangular, pentagonal, or hexagonal. Optionally, each face 1456 can have a different width. In another embodiment, one or more of the faces 1456 is not linear.

A shoulder 1465 may be formed between the abutment 1452 and the extension 1466. Specifically, the abutment 1452 generally has a greater diameter than the extension. Accordingly, in one embodiment, a shoulder 1465 extends outwardly from the extension 1466. The should 1465 has a geometry to engage an upper surface 1426 of the first stage implant 1422. Optionally, the shoulder 1465 may be generally linear. In embodiment, the shoulder 1465 extends outwardly approximately perpendicular to a longitudinal axis of the second stage implant 1450.

The abutment 1452 has a shape with an anatomical emergence profile. The shape of the abutment 1452 will vary depending on the location of the implant site 1410 and the tooth being replaced. The base of the abutment can have an exterior shape selected to match the profile of a natural tooth where the base passes into the jawbone. In this manner, the exterior shape of the abutment can distribute forces generated during mastication over a large surface area into the surrounding jawbone. In one embodiment, the exterior surfaces of the abutment 1452 are selected to correspond to the shape of a tooth of the patient being replaced. For example, the abutment 1452 may be formed by a CAD-CAM system using medical images (such as x-rays) of the tooth formerly at the implant site 1410.

The abutment may also include a platform switch comprising a groove 1464. The groove 1464 may be inwardly tapered. Optionally, the groove 1464 extends around the circumference of the abutment 1452. The groove 1464 facilitates good attachment of gum tissue 1404 to the abutment. Accordingly, the groove can prevent bone loss. In one embodiment, the groove has a depth that is substantially constant around the abutment 1452. Alternatively, the depth of the groove may vary. In one embodiment, the depth of the groove is from about 0.01 mm to about 5 mm. In one embodiment, the cross-sectional geometric profile of the groove 1464 is at least one of a semicircle, a U-shape, and a V-shape.

The abutment generally includes a collar 1458, a gum contact portion 1460, and a bone engagement portion 1462. The bone engagement portion 1462 is configured to contact bone tissue 1406 of the upper portion 1413 of the implant cavity 1412. In one embodiment, the groove 11464 is formed approximately at a transition from the bone engagement portion 1462 to the gum contact portion 1460. In another embodiment, the bone engagement portion 1462 generally extends from the shoulder 1465 to the groove 1464.

The exterior surface of the bone engagement portion 1462 is configured to promote osseointegration with the bone tissue 1406 in a manner the same as, or similar to, the exterior surfaces of the first stage implant 1422. Exterior surfaces of one or more of the first stage implant 1422 and the second stage implant 1450 can be formed or treated to improve osteointegration as described in U.S. Pat. No. 8,241,036, U.S. Pat. No. 8,814,569, U.S. Pat. No. 9,387,506, U.S. Pat. No. 9,421,301, U.S. Pat. Pub. US2008/0044795, and PCT Pub. WO 2008/128757 which are each incorporated herein by reference in their entirety.

In one embodiment, at least the bone engagement portion 1462 of the abutment 1452 can be roughened to promote osseointegration. The bone engagement portion can be roughened in several different ways, including one or more of acid-etching, grit blasting, and machining. Additionally, or alternatively, the bone engagement portion 1462 may be coated with a substance selected to promote osseointegration. In one embodiment, calcium phosphate ceramics can be added to the bone engagement portion 1462 to enhance osseointegration by changing the chemistry of the bone engagement portion. The calcium phosphate ceramics may include tricalcium phosphate (TCP) and hydroxyapatite (HA).

In another embodiment, macroscopic structures can be formed on the bone engagement portion 1462 including, but not limited to, threads 1455, micro-threads, indentations, pores, and/or grooves that are configured to promote osseointegration. In another embodiment, the bone engagement portion 1462 comprises a microstructure surface, such as, a highly crystalline and phosphate enriched titanium oxide micro-structured surface with open pores in the low micrometer range. In yet another embodiment, the abutment 1452 is formed of zirconium ceramic and is coated with porous zirconium to provide a microstructure surface. Optionally, at least the bone engagement portion 1462 of the abutment is coated with a porous layer. In one embodiment, a bone growth stimulating substance can be positioned within pores of the porous layer or coating. One or more of the osseointegration features and techniques can be added to at least the bone engagement portion 1462 of the abutment.

In one embodiment, at least the bone engagement portion 1462 of the second stage implant 1450 includes the threads 1455. The threads 1455 provide additional surfaces for the bone tissue 1406 to engage or grow into. Any number of threads may be formed on the bone engagement portion 1462. Additionally, the size and configuration of the threads may vary. More specifically, a first thread may have a size and configuration that is different than a second thread.

In one embodiment, the second state implant 1450 is not configured to be rotated relative to the first stage implant 1422 or the bone tissue 1406. Specifically, the threads 1455 are not intended to rotationally engage the bone tissue 1406. Accordingly, the threads 1455 can have different geometries and orientations compared to the threads 1432 of the first stage implant. More specifically, in one embodiment, one or more of the threads 1432 may spiral around the abutment 1452 in a first direction. Additionally, or alternatively, one or more of the threads can spiral around the abutment in a second direction. Optionally, in another embodiment, a thread may not be helical. Accordingly, at least one thread may be oriented substantially perpendicular to a longitudinal axis of the second stage implant 1450. In still another embodiment, a first thread intersects at least one other thread 1455. In one embodiment, the threads 1455 have a width of up to approximately 160 microns and a depth of up to approximately 60 microns.

The gum contact portion 1460 has an exterior surface adapted to promote attachment of gum tissue to the abutment 1452. In one embodiment, the exterior surface of the gum contact portion 1460 can be machine milled and/or polished to provide a smooth surface to which the gum tissue 1404 will attach. Optionally, one or more semicircular grooves can be positioned around the circumference of the gum contact portion 1460. The grooves provide additional surfaces for the gum tissue 1404 to engage or grow into. The grooves (not illustrated for clarity), in one embodiment, can have a width of up to approximately 160 microns and a depth of up to approximately 60 microns. Any number of grooves may be formed on the gum contact portion 1460. Additionally, the size and configuration of the grooves may be different or substantially the same.

In another embodiment, adapting the gum contact portion 1460 to promote attachment of gum tissue includes forming circumferential protrusions or micro-threads on the gum contact portion. Additionally, or alternatively, the gum contact portion 1460 of the abutment can be treated in a variety of ways, such as by one or more of: (i) mechanical etching (e.g., machining, milling, grinding, grit blasting); (ii) chemical etching (e.g., acid-etching); (iii) electric discharge machines; (iv) laser etching; and (v) application of textured surfaces (e.g., calcium phosphate ceramics, such as tricalcium phosphate (TCP) and hydroxyapatite (HA)).

Additionally, or alternatively, the gum contact portion 1460 can be at least partially, or completely, hydroxylated or silanated. The gum contact portion 1460 may be smoothed, for example by electropolishing. Alternatively, in another embodiment, the gum contact portion is roughened, for example, by sandblasting. In one embodiment, the gum contact portion is also hydrophilic in order to ensure an optimal integration of gum tissue 1404. Optionally, the gum contact portion 1460 can be colored to resemble the gum tissue 1404.

Although boundaries of the bone engagement portion 1462 and the gum contact portion 1460 are illustrated in FIG. 18B as being approximately perpendicular to a longitudinal axis of the second stage implant 1450, in other embodiments, portions 1460, 1462 are formed on the abutment 1452 to align with the bone tissue 1406 and gum tissue 1404 at the implant site 1410. Accordingly, an upper edge of the bone engagement portion 1462 may be contoured to follow the topographical shape of the jaw bone tissue 1406 at the implant site. Similarly, an upper edge of the gum contact portion 1460 may be contoured to follow the gum tissue at the implant site. The gum contact portion 1460 may have any thickness necessary to conform to the contours of gum tissue 1404 at the implant site. In one embodiment, the gum contact portion 1460 has a thickness of between about 2 mm and about 5 mm.

The collar 1458 is configured to extend a predetermined distance above the crest of the gum tissue 1404 as generally illustrated in FIG. 20. The collar 1458 sets the emergence profile for a molar or other tooth being replaced at the implant site. More specifically, at least the collar 1458 of the abutment 1452 has a root form which substantially conforms to the anatomy of the tooth being replaced. The collar 1458 is configured to extend a predetermined distance above the crest of the gum tissue. In one embodiment, the collar is configured to extend up to approximately 5 mm above the gum tissue at the implant site.

A recess 1470 is provided in the abutment 1452. The recess may be adapted to receive a crown 1488. The recess 1470 may have any shape configured to prevent unintended or inadvertent movement of the crown. One or more contact surfaces 1472 can be provided in the recess which are configured to engage the crown. In one embodiment, the recess includes from three to eight contact surfaces 1472. Optionally, the recess includes six contact surfaces 1472 arranged in a hexagonal shape as generally illustrated in FIG. 18C. However, although the recess 1470 is illustrated as a regular hexagon, the angles between the contact surfaces and the shapes of individual contact surfaces may be varied. Accordingly, the recess 1470 may have the shape of an irregular polygon, such as an irregular hexagon.

Additionally, or alternatively, in one embodiment the recess 1470 includes a projection (not illustrated). The projection may be the same as, or similar to, the projections 140 described herein. The projection is configured to engage a groove formed on the crown 1488.

An aperture 1474 extends through the second stage implant 1450. The aperture 1474 is oriented to align with a cylindrical bore 1438 of a first stage implant 1422 to which the second stage implant is engaged. In this manner, a threaded fastener 1480 can extend through the second stage implant 1450 into the cylindrical bore 1438 to interconnect the first and second stage implants. The aperture 1474 may optionally include threads 1476 to engage the threaded fastener. However, in one embodiment, the aperture 1474 is not threaded. Optionally, a countersink is provided with the aperture 1474 to receive a head of the threaded fastener 1480.

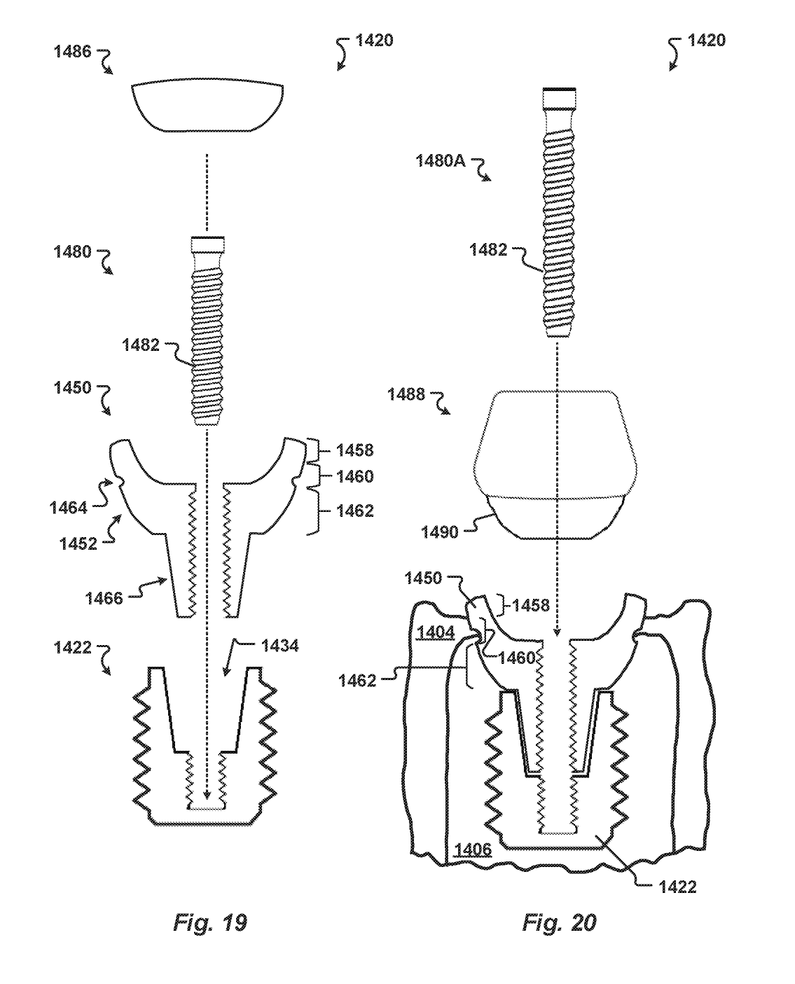

Referring now to FIG. 19, an implant system 1420 of one embodiment of the present disclosure is illustrated. After the implant cavity 1412 is prepared, a first stage implant 1422 of the implant system may be threaded into the cavity lower portion 1415. A second stage implant 1450 is subsequently positioned in the first stage implant. A threaded fastener 1480 can then be inserted through the aperture 1474 of the second stage implant 1450 to engage the threads 1440 of the cylindrical bore 1438. Optionally, the threaded fastener 1480 may extend through the distal end 1430 of the first stage implant 1422 into the bone tissue.

Optionally, a healing cap 1486 can be positioned in the recess 1470 of the second stage implant 1450. Suitable healing caps that may be used with the implant system 1420 of the present disclosure are described in U.S. Pat. No. 6,394,806 which is incorporated herein by reference in its entirety.

The gum tissue 1404 of the implant site may then be closed around the implant system 1420. The gum tissue 1404 may then heal around the second stage implant 1450 while bone tissue 1406 suitably integrates into surfaces of the first and second stage implants.

Referring now to FIG. 20, after sufficient osteointegration of the bone tissue and the implant system 1420 has occurred, the optional healing cap 1486 is removed from the second stage implant 1450. The gum tissue 1404 at the implant site 1410 does not need to be disturbed to remove the healing cap 1486. Accordingly, the implant system 1420 of the present disclosure promotes healthy gum tissue at the implant site compared to prior art implants which require gum tissue which has healed during osteointegration to be disturbed around the implant to prepare the implant to receive a crown or other abutment.

The threaded fastener 1480 may optionally be removed from the first and second stage implants. A crown 1488 is then positioned in the recess 1470 of the second stage implant 1450.

In one embodiment, the crown 1488 includes a projection 1490 configured to engage the contact surfaces 1472 of the second stage implant recess 1470. In one embodiment, the projection 1490 is configured to prevent rotation of the crown relative to the second stage implant 1450. Optionally, the projection 1490 has a shape that is generally hexagonal. However, other shapes for the projection 1490 are contemplated. Additionally, or alternatively, the projection 1490 may include at least one groove configured to engage a projection extending inwardly within the recess 1470 of the second stage implant.

In one embodiment, the projection 1490 may be configured to align the crown 1488 in a predetermined orientation with respect to the second stage implant at the implant site 1410. For example, the projection 1490 may fit into the recess 1470 such that the crown 1488 is aligned with other teeth at proximate to the implant site 1410.

In one embodiment, the crown includes a bore (not illustrated) to receive a second threaded fastener 1480A. In this manner, the second threaded fastener 1480A may extend through the crown to interconnect the crown to one or more of the first and second stage implants 1422, 1450. Accordingly, the crown 1488 can be one or more of cemented, glued, screwed, or otherwise affixed to the recess 1470. Optionally, the crown can be colored to match the implant site.

One or more elements of the implant system 1420 of the present disclosure can be manufactured to be specific to the implant site. More specifically, the implant system may be patient specific. Accordingly, the size and geometry of one or more of the first stage implant 1422, the second stage implant 1450, and the crown 1488 can be prepared by a CAD-CAM system which may include the use of a milling machine or powder metallurgy (or other form of additive manufacturing process, such as 3D printing). Further, the elements of the implant system 1420 can be designed to account for the anatomic features of the patient at the implant site 1410. For example, the first and second stage implants 1422, 1450 may be sized based on the density of the patient's bone tissue 1406. Similarly, the threads 1432 of the first stage implant 1422 may have a geometry configured to engage the patient's bone tissue 1406. Accordingly, the geometry of the threads 1432 may change along the length of the first stage implant 1422 based on the density of the patient's bone tissue.

Additionally, the cylindrical bore 1438 of the first stage implant can extend through the body 1424 and be oriented to target bone tissue 1406 having a predetermined density. Accordingly, in one embodiment, the cylindrical bore 1438 may be aligned transverse to a longitudinal axis of first stage implant to target bone tissue with a predetermined density or to avoid bone tissue with an insufficient density. Thus, in one embodiment, a threaded fastener 1480, 1480A may extend from the first stage implant through the sidewall 1428 or the distal end 1430 to engage targeted bone tissue.

To provide additional background, context, and to further satisfy the written description requirements of 35 U.S.C. § 112, the following references are incorporated herein by reference in their entireties: U.S. Pat. No. 3,386,169; U.S. Pat. No. 5,281,140; U.S. Pat. No. 5,316,476; U.S. Pat. No. 5,584,693; U.S. Pat. No. 5,622,500; U.S. Pat. No. 5,890,902; U.S. Pat. No. 5,984,681; U.S. Pat. No. 6,039,568; U.S. Pat. No. 6,083,004; U.S. Pat. No. 6,394,806; U.S. Pat. No. 6,419,491; U.S. Pat. No. 6,431,866; U.S. Pat. No. 6,447,295; U.S. Pat. No. 6,454,569; U.S. Pat. No. 6,527,554; U.S. Pat. No. 6,537,069; U.S. Pat. No. 6,626,911; U.S. Pat. No. 6,857,874; U.S. Pat. No. 7,806,685; U.S. Pat. No. 7,942,670; U.S. Pat. No. 8,029,283; U.S. Pat. No. 8,038,442; U.S. Pat. No. 8,167,618; U.S. Pat. No. 8,197,255; U.S. Pat. No. 8,241,036; U.S. Pat. No. 8,439,919; U.S. Pat. No. 8,714,977; U.S. Pat. No. 8,721,335; U.S. Pat. No. 8,758,012; U.S. Pat. No. 8,764,443; U.S. Pat. No. 8,814,569; U.S. Pat. No. 8,827,703; U.S. Pat. No. 8,915,735; U.S. Pat. No. 8,968,002; U.S. Pat. No. 9,125,708; U.S. Pat. No. 9,387,506; U.S. Pat. No. 9,421,301; U.S. Pat. No. 9,463,078; U.S. Pat. No. 9,642,680; U.S. Pat. No. 9,668,833; U.S. Pat. No. 9,737,392; U.S. Patent Pub. 2003/0143514; U.S. Patent Pub. 2004/0101808; U.S. Patent Pub. 2007/0037123; U.S. Patent Pub. 2008/0032262; U.S. Patent Pub. 2008/0044795; U.S. Patent Pub. 2008/0118892; U.S. Patent Pub. 2008/0254411; U.S. Patent Pub. 2009/0291414; U.S. Patent Pub. 2011/0086327; U.S. Patent Pub. 2016/0000967; and PCT Pub. WO 2008/128757.

The foregoing description of the present disclosure has been presented for purposes of illustration and description. Furthermore, the description is not intended to limit the disclosure to the form disclosed herein. Consequently, variations and modifications commensurate with the above teachings, and the skill or knowledge of the relevant art, are within the scope of the present disclosure. The embodiments described hereinabove are further intended to explain the best mode known for practicing the disclosure and to enable others skilled in the art to utilize the disclosure in such, or other, embodiments and with various modifications required by the particular applications or uses of the present disclosure. It is intended that the appended claims be construed to include alternative embodiments to the extent permitted by the prior art.

What is claimed is:

1. A dental implant system adapted to be embedded within a patient's jawbone comprising:
a first stage implant to engage the jawbone; and
a second stage implant interconnectable to the first stage implant, the second stage implant having an abutment with a recess configured to receive a crown, wherein the abutment has a non-cylindrical shape.

2. The dental implant system of claim 1, wherein the first stage implant further comprises external threads.

3. The dental implant system of claim 1, wherein the first stage implant further comprises a chamber to receive an extension of the second stage implant, the chamber configured to prevent rotation of the extension.

4. The dental implant system of claim 3, wherein the chamber has six interior walls arranged in a shape that is approximately hexagonal.

5. The dental implant system of claim 1, wherein an exterior surface of each of the first stage implant and the abutment of the second stage implant are configured to promote osseointegration.

6. The dental implant system of claim 1, wherein the abutment of the second stage implant further comprises:
a bone engagement portion configured to promote osseointegration;
a gum contact portion configured to promote attachment of the patient's gum tissue to the abutment; and
a collar configured to extend above the patient's gum tissue.

7. The dental implant system of claim 6, wherein the bone engagement portion has a rough surface texture and the gum contact portion has a smooth or polished surface texture.

8. The dental implant system of claim 6, wherein the second stage implant further comprises a groove extending around a circumference of the abutment, the groove associated with one or more of the gum contact portion and the bone engagement portion.

9. The dental implant system of claim 1, wherein the abutment of the second stage implant has an anatomical emergence profile selected to substantially match an emergence profile of a tooth to be replaced by the dental implant system.

10. The dental implant system of claim 1, wherein the recess of the abutment has a generally pentagonal or hexagonal shape.

11. The dental implant system of claim 1, wherein the first stage implant further comprises a cylindrical bore configured to receive a threaded fastener to secure the second stage implant to the first stage implant.

12. The dental implant system of claim 11, wherein the cylindrical bore does not extend through the first stage implant.

13. The dental implant system of claim 11, wherein the cylindrical bore extends through the first stage implant such that the threaded fastener can engage the patient's jawbone.

14. A method for securing a dental implant system to a patient's jawbone, comprising:
forming an implant cavity in the jawbone to receive a first stage implant;
expanding an upper portion of the implant cavity to accept an abutment of a second stage implant, the abutment having a non-cylindrical shape;
threading the first stage implant into a lower portion of the implant cavity;
positioning an extension of the second stage implant in a chamber of the first stage implant such that an exterior surface of the abutment contacts bone tissue in the upper portion of the implant cavity; and
securing a threaded fastener through the second stage implant into the first stage implant.

15. The method of claim 14, wherein expanding the upper portion of the implant cavity comprises removing bone tissue to shape the implant cavity to accept the abutment, wherein the abutment has an anatomical emergence profile selected to substantially match an emergence profile of a tooth to be replaced by the dental implant system.

16. The method of claim 14, further comprising forming threads in the lower portion of the implant cavity, the threads configured to engage external threads of the first stage implant.

17. The method of claim 14, further comprising affixing a crown in a recess of the second stage implant.

18. The method of claim 17, further comprising closing gum tissue around the second stage implant after securing the threaded fastener into the first stage implant.

19. The method of claim 18, wherein the gum tissue is not cut when the crown is affixed to the second stage implant.

20. The method of claim 14, wherein the threaded fastener extends through the first stage implant into bone tissue.
